(19) United States
(12) Patent Application Publication
(10) Pub. No.: US 2025/0386828 A1
(43) Pub. Date: Dec. 25, 2025

(54) PLANT GROWTH PROMOTER

(71) Applicant: NIPPON PAPER INDUSTRIES CO., LTD., Tokyo (JP)

(72) Inventors: Akira SHIBATA, Tokyo (JP); Akihiko NAKAMURA, Tokyo (JP)

(73) Assignee: NIPPON PAPER INDUSTRIES CO., LTD., Tokyo (JP)

(21) Appl. No.: 18/879,457

(22) PCT Filed: Jul. 18, 2023
(86) PCT No.: PCT/JP2023/026281

§ 371 Date: Dec. 27, 2024

(30) Foreign Application Priority Data
Jul. 20, 2022 (JP) 2022-115286
Mar. 22, 2023 (JP) 2023-045896

(51) Int. Cl. A01N 65/00; A01P 21/00

(52) U.S. Cl. CPC A01N 65/00; A01P 21/00

(57) ABSTRACT

A plant growth promoter, including: a lignin sulfonic acid component, where a phenolic hydroxyl group content of the lignin sulfonic acid component is 0.1% to 3.5% by weight, a methoxyl group content of the lignin sulfonic acid component is 1.0% to 15.0% by weight, and a sulfone group-derived sulfur atom content of the lignin sulfonic acid component is 2.0% by weight or higher. A biostimulant, including: a lignin sulfonic acid component, where a phenolic hydroxyl group content of the lignin sulfonic acid component is 0.1% to 3.5% by weight, a methoxyl group content of the lignin sulfonic acid component is 1.0% to 15.0% by weight, and a sulfone group-derived sulfur atom content of the lignin sulfonic acid component is 2.0% by weight or higher.

### FIELD

The present invention relates to a plant growth promoter.

### BACKGROUND

Lignin is a macromolecular phenolic polymer contained in a plant tissue. When plants are decomposed by soil microorganisms, a lignin degradation product is produced as an intermediate product, and the lignin degradation product binds to a peptide, an amino acid, and the like resulting from the degradation of a microbial protein to produce humic acid. Humic acid promotes plant growth and also has the effects of enhancing soil fertility and activating soil microorganisms. Therefore, lignin has been used to promote the growth of plants such as crops.

Patent Literature 1 describes a plant-activating agent including, as an active ingredient, a lignin degradation product having an aldehyde yield resulting from alkaline nitrobenzene oxidation of 10% by mass or higher.

Patent Literature 2 describes a plant growth promoter including a granular plant-seed husk component having a lignin content of 40% by mass or higher and 60% by mass or lower.

### CITATION LIST

### Patent Literature

Patent Literature 1: Japanese Patent Application Laid-open No. 2017-190331

Patent Literature 2: WO 2019/078209

### SUMMARY

### Technical Problem

For the further utilization of lignin, the development of a lignin derivative capable of achieving a higher growth-promoting effect on plants than the agents described in Patent Literatures 1 and 2 has been needed. However, improvement in yield was sometimes insufficient. The present invention is proposed in view of the above-described problem, and an object of the present invention is to provide a plant growth promoter including a lignin-based compound as an active ingredient and being capable of efficiently promoting plant growth.

### Solution to Problem

The present invention provides the following <1> to <8>.

<1> A plant growth promoter, comprising a lignin sulfonic acid component, wherein
a phenolic hydroxyl group content of the lignin sulfonic acid component is 0.1% to 3.5% by weight, a methoxyl group content of the lignin sulfonic acid component is 1.0% to 15.0% by weight, and a sulfone group-derived sulfur atom content of the lignin sulfonic acid component is 2.0% or higher.

<2> The plant growth promoter according to <1>, wherein at least one of:
a reducing sugar content of the lignin sulfonic acid component is 35% by weight or lower;
a sulfur atom content of the lignin sulfonic acid component is 3.0% by weight or higher; and
a sodium atom content of the lignin sulfonic acid component is 0.3% by weight or higher, is satisfied.

<3> The plant growth promoter according to <1> or <2>, wherein a carboxyl group content of the lignin sulfonic acid component is 0.1 to 4.5 mmol/g.

<4> The plant growth promoter according to any one of <1> to <3>, wherein a weight average molecular weight (RI) of the lignin sulfonic acid component is 3,000 or more.

<5> The plant growth promoter according to any one of <1> to <4>, wherein the lignin sulfonic acid comprises a substituent derived from (poly)alkylene oxide.

<6> A biostimulant, comprising a lignin sulfonic acid component, wherein
a phenolic hydroxyl group content of the lignin sulfonic acid component is 0.1% to 3.5% by weight, a methoxyl group content of the lignin sulfonic acid component is 1.0% to 15.0% by weight, and a sulfone group-derived sulfur atom content of the lignin sulfonic acid component is 2.0% or higher.

<7> A plant production method, comprising
cultivating a plant by using the plant growth promoter according to any one of <1> to <5> or the biostimulant according to <6>

<8> A plant cultivation kit, comprising:
the plant growth promoter according to any one of <1> to <5> or the biostimulant according to <6>; and
a seed or a seedling of a plant.

<9> Use of a lignin sulfonic acid for production of a plant growth promoter or a biostimulant, wherein a phenolic hydroxyl group content of the lignin sulfonic acid is 0.1% to 3.5% by weight, a methoxyl group content of the lignin sulfonic acid is 1.0% to 15.0% by weight, and a sulfone group-derived sulfur atom content of the lignin sulfonic acid is 2.0% or higher.

### Advantageous Effects of Invention

The present invention provides a plant growth promoter and a biostimulant that are capable of promoting the growth of various plants. The plant growth promoter and the biostimulant according to the present invention can be applied regardless of plant growth time and conditions, and accordingly can lead to increased production and increased yield of crops in the agricultural field.

### DESCRIPTION OF EMBODIMENTS

### <1. Lignin Sulfonic Acid Component>

A plant growth promoter according to the present invention comprises a lignin sulfonic acid component.

### <Lignin Sulfonic Acid>

The lignin sulfonic acid component mainly comprises lignin sulfonic acid and is usually derived from sulfite cooking of pulp. Lignin sulfonic acid is a compound having a skeleton in which a sulfone group is introduced by the cleavage of carbon at the α-position of a side chain in the hydroxyphenylpropane structure of lignin.

Lignin sulfonic acid can be in the form of a salt. Examples of the salt may include monovalent metal salts, divalent metal salts, ammonium salts, and organic ammonium salts. Among these salts, a calcium salt, a magnesium salt, a sodium salt, and a mixed salt of calcium and sodium are preferred.

### <Substituent>

Lignin sulfonic acid comprises a substituent other than the sulfone group. The substituent may be a lignin-derived substituent or may be a substituent not originally included in lignin, but introduced by modification treatment. Examples of the substituent may include hydroxyl groups (a phenolic hydroxyl group, an alcoholic hydroxyl group), a methoxyl group, a carboxyl group, a sulfomethyl group, an aminomethyl group, and a (poly)alkylene oxide group. Among these substituents, a phenolic hydroxyl group, a methoxyl group, a sulfone group, or a (poly)alkylene oxide group is more preferably comprised within a predetermined range. Thus, plant growth can be promoted.

### —Phenolic Hydroxyl Group—

The phenolic hydroxyl group is generally a hydroxyl group bound directly to an aromatic ring such as benzene. The content of the phenolic hydroxyl group is preferably 0.1% by weight or higher, more preferably 0.5% by weight or higher, still more preferably 1.0% by weight or higher, still more preferably 1.1% by weight or higher with respect to the total weight of the lignin sulfonic acid component. The upper limit of the content of the phenolic hydroxyl group is preferably 3.5% by weight or lower, more preferably 3.3% by weight or lower, still more preferably 3.0% by weight or lower, still more preferably 2.7% by weight or lower. Hence, the content of the phenolic hydroxyl group in the lignin sulfonic acid is preferably 0.1% to 3.5% by weight, more preferably 0.5% to 3.3% by weight, still more preferably 1.0% to 3.0% by weight, still more preferably 1.1% to 2.7% by weight. The content of the phenolic hydroxyl group can be determined from a value of absorbance measured using a spectrophotometer.

### —Methoxyl Group—

The methoxyl group is a group represented by a formula: —OCH₃. The content of the methoxyl group is preferably 1.0% by weight or higher, more preferably 3.0% by weight or higher, still more preferably 5.0% by weight or higher, still more preferably 6.0% by weight or higher with respect to the total weight of the lignin sulfonic acid component. The upper limit of the content of the methoxyl group is preferably 15.0% by weight or lower, more preferably 13.0% by weight or lower, still more preferably 12.0% by weight or lower, still more preferably 11.5% by weight or lower. Hence, the content of the methoxyl group is preferably 1.0% to 15.0% by weight, more preferably 3.0% to 13.0% by weight, still more preferably 5.0% to 12.0% by weight, still more preferably 6.0% to 11.5% by weight. The methoxyl group content of lignin can be measured by the Viebock and Schwappach method.

### —Sulfone Group—

A sulfone group (sulfonic acid group, sulfo group) is generally represented by a formula: —SO₃⁻M⁺ (M is a counter cation (for example, H, Na, Ca, Mg, or NH₄)). The content of the sulfone group can be expressed by the content of sulfur atom derived from the sulfone group (the content of S in the sulfone group). The content of S in the sulfone group is preferably 2.0% or higher, more preferably 3.0% or higher, still more preferably 4.0% or higher, still more preferably 4.5% or higher, with respect to the total amount of the lignin sulfonic acid component. The upper limit of the content of S in the sulfone group is not particularly limited and is preferably 10.0% or lower, more preferably 9.0% or lower, still more preferably 8.0% or lower, still more preferably 7.0% or lower. Hence, the content of S in the sulfone group is preferably 2.0% to 10.0%, more preferably 3.0% to 9.0%, still more preferably 4.0% to 8.0%, still more preferably 4.5% to 7.0%. The content of S in the sulfone group can be determined by subtracting the content of sulfur atoms in an inorganic form from the content of all sulfur atoms in the lignin sulfonic acid.

### —Carboxyl Group—

The carboxyl group is generally represented by a formula: —COOM⁺ (M is a counter cation (for example, H, Na, Ca, Mg, NH₄)). The content of the carboxyl group is preferably within a certain range. That is, the content of the carboxyl group is preferably 0.1 mmol/g or more, more preferably 0.3 mmol/g or more, still more preferably 0.5 mmol/g or more with respect to the weight of the lignin sulfonic acid component. The upper limit of the content of the carboxyl group is preferably 4.5 mmol/g or less, more preferably 4.0 mmol/g or less, still more preferably 3.0 mmol/g or less. Hence, the content of the carboxyl group is preferably 0.1 to 4.5 mmol/g, more preferably 0.3 to 4.0 mmol/g, still more preferably 0.5 to 3.0 mmol/g. The content of the carboxyl group can be determined by neutralization titration.

### —(Poly)Alkylene Glycol Group—

The (poly)alkylene glycol group is a substituent derived from (poly)alkylene oxide. The average number of moles of an alkylene oxide unit added that constitutes polyalkylene glycol is usually 1 or larger, 5 or larger, or 10 or larger, preferably 15 or larger, more preferably 20 or larger, still more preferably 25 or larger, or 30 or larger, still more preferably 35 or larger. Thus, good dispersibility can be achieved. In particular, the average number of moles of the alkylene oxide unit added is preferably 50 or larger, 60 or larger, 70 or larger, 80 or larger, or 90 or larger, because spreadability on a water surface can be further enhanced. The upper limit of the average number of moles of the alkylene oxide unit added is usually 300 or less or 200 or less, preferably 190 or less, more preferably 180 or less, still more preferably 170 or less. Thus, dispersion retention can be prevented from decreasing. Hence, the average number of moles added is usually 10 to 200, preferably 15 to 190, more preferably 20 to 180, still more preferably 25 to 170. On the other hand, the average number of moles added may be preferably 25 to 300, more preferably 30 to 200, still more preferably 35 to 150. The number of carbon atoms of the polyalkylene glycol is not particularly limited and is usually 2 to 18, preferably of 2 to 4, more preferably 2 to 3. Examples of the alkylene oxide unit may include an ethylene oxide unit, a propylene oxide unit, and a butylene oxide unit. An ethylene oxide unit or a propylene oxide unit is preferred. Examples of the lignin sulfonic acid including the (poly)alkylene oxide group may include a lignin derivative described in WO 2021/066166.

### <Inorganic Component>

The lignin sulfonic acid component may further include an inorganic component. Examples of the inorganic component may include inorganic salts, such as a salt of sulfur, calcium, sodium, magnesium, nitrogen, phosphorus, potassium, and iron, ammonia, oxides of the inorganic salts (such as sulfur oxide, magnesium oxide, and calcium oxide), hydroxides of the inorganic salts (such as magnesium hydroxide, calcium hydroxide, sodium hydroxide, and ammonium hydroxide), carbonates of the inorganic salts (such as calcium carbonate and sodium carbonate), and nitric acid. The aspect of the inorganic component is not particularly limited and may be a counter cation of the lignin sulfonic acid or a free inorganic component thereof (for example, an inorganic component added during the production of the lignin sulfonic acid). Among them, at least one of sulfur, calcium, sodium, magnesium, nitrogen, phosphorus, and potassium is preferably included.

### —Sulfur Ion—

The content of sulfur ions can be expressed as the content of sulfur atoms (the total S content) in the lignin sulfonic acid. The total S content is preferably 3.0% by weight or higher, more preferably 4.0% by weight or higher, still more preferably 5.0% by weight or higher. The upper limit of the total S content is not particularly limited and is preferably 10.0% by weight or lower, more preferably 9.0% by weight or lower, still more preferably 8.0% by weight or lower. Hence, the S content is preferably 3.0% to 10.0% by weight, more preferably 4.0% to 9.0% by weight, still more preferably 5.0% to 8.0% by weight. The total S content can be determined by ICP emission spectrometry.

### —Sulfur Oxide—

The lignin sulfonic acid may include sulfur oxide. Examples of the sulfur oxide may include sulfur dioxide (SO₂), sulfur trioxide (SO₃), and sulfur tetroxide (SO₄). SO₃ and SO₄ are preferred. There is a possibility that SO₃ changes into the form of SO₄, and the content of SO₃ is usually 0% by weight or higher, preferably 0.001% by weight or higher, more preferably 0.005% by weight or higher, still more preferably 0.01% by weight or higher or 0.04% by weight or higher. The upper limit of the content of SO₃ is preferably 3.0% by weight or lower, more preferably 2.0% by weight or lower, still more preferably 1.0% by weight or lower, still more preferably 0.5% by weight or lower. Hence, the content of SO₃ is usually 0% to 3.0% by weight, preferably 0.001% to 3.0% by weight, more preferably 0.005% to 2.0% by weight, still more preferably 0.01% to 1.0% by weight, still more preferably 0.04% to 0.5% by weight. The content of SO₄ is preferably 0.2% by weight or higher, more preferably 0.4% by weight or higher, still more preferably 0.5% by weight or higher, 2.0% by weight or higher, or 3.0% by weight or higher. The upper limit of the content of SO₄ is preferably 10% by weight or lower, more preferably 9.5% by weight or lower, still more preferably 9.0% by weight or lower. Hence, the content of SO₄ is preferably 0.2% to 10% by weight, more preferably 0.4% to 9.5% by weight, still more preferably 0.5% to 9.0% by weight, still more preferably 2.0% to 9.0% by weight or 3.0% to 9.0% by weight. The content of the sulfur oxide can be determined by ion chromatography.

### —Ratio of Amount of Sulfone Group-Derived S to Total S Content—

The ratio of the amount of sulfone group-derived sulfur atoms relative to the amount of sulfur atoms contained in the lignin sulfonic acid is preferably 0.5 or more, more preferably 0.6 or more. The upper limit of the ratio is not particularly limited and is usually 0.95 or less, preferably 0.9 or less.

—Ratio of SO₃ to SO₄—

The ratio of the amount of SO₃ relative to the amount of SO₄ contained in the lignin sulfonic acid is usually 0 or more, preferably 0.01 or more, more preferably 0.02 or more. The upper limit of the ratio is preferably 0.5 or less, more preferably 0.4 or less.

### —Sodium Ion, Calcium Ion, and Magnesium Ion—

The Nat ion content, the Ca²⁺ ion content, and the Mg²⁺ ion content can be expressed as their respective atomic contents. The sodium atom content (Na content) is preferably 0.3% by weight or higher, more preferably 0.4% by weight or higher, still more preferably 0.5% by weight or higher. The upper limit of the Na content is not particularly limited and is preferably 10.0% by weight or lower, more preferably 9.0% by weight or lower, still more preferably 8.0% by weight or lower. Hence, the Na content is preferably 0.3% to 10.0% by weight, more preferably 0.4% to 9.0% by weight, still more preferably 0.5% to 8.0% by weight. The calcium atom content (Ca content) is preferably 0.001% by weight or higher, more preferably 0.01% by weight or higher, still more preferably 0.03% by weight or higher. The upper limit of the Ca content is preferably 5.0% by weight or lower, more preferably 4.0% by weight or lower, still more preferably 1.0% by weight or lower. Hence, the Ca content is preferably 0.001% to 5.0% by weight, more preferably 0.01% to 4.0% by weight, still more preferably 0.03% to 1.0% by weight. The magnesium atom content (Mg content) is preferably 0.05% by weight or higher, more preferably 0.07% by weight or higher, still more preferably 0.1% by weight or higher, 0.5% by weight or higher, 1.0% by weight or higher, 2.0% by weight or higher, 3.0% by weight or higher, or 3.2% by weight or higher. The upper limit of the Mg content is preferably 10.0% by weight or lower, more preferably 8.0% by weight or lower, still more preferably 5.0% by weight or lower. Hence, the Mg content is preferably 0.05% to 10.0% by weight, more preferably 0.07% to 8.0% by weight, still more preferably 0.1% to 5.0% by weight, 0.5% to 5.0% by weight, 1.0% to 5.0% by weight, 2.0% to 5.0% by weight, 3.0% to 5.0% by weight, or 3.2% to 5.0% by weight. The Na content, the Ca content, and the Mg content can be determined by the inductively coupled plasma (ICP) method.

### —Reducing Sugars—

The lignin sulfonic acid component preferably further includes a reducing sugar. In the present specification, reducing sugars refer to saccharides having reducing properties, that is, the property of producing an aldehyde group or a ketone group in a basic solution. Examples of the reducing sugars may include: all types of monosaccharides; disaccharides, such as maltose, lactose, arabinose, and sucrose invert sugars; and polysaccharides. The reducing sugars usually include cellulose, hemicellulose, and degradation products thereof. Examples of the degradation products of cellulose and hemicellulose may include: monosaccharides, such as rhamnose, galactose, arabinose, xylose, glucose, mannose, and fructose; oligosaccharides, such as xylooligosaccharides and cellooligosaccharides; and modified products thereof. The modified products are chemically modified products such as oxides and sulfonated products, and examples thereof may include: sugar derivatives in which a functional group, such as a hydroxyl group, an aldehyde group, a carbonyl group, or a sulfo group, is introduced into a sugar skeleton; and compounds in which two or more (types) of the sugar derivatives are bound to each other.

The reducing sugar content is preferably 0.1% by weight or higher, more preferably 0.3% by weight or higher, still more preferably 0.5% by weight or higher or 2.0% by weight or higher. The upper limit of the reducing sugar content is preferably 35% by weight or lower, more preferably 30% by weight or lower, still more preferably 25% by weight or lower. Hence, the reducing sugar content is preferably 0.1% to 35% by weight, more preferably 0.3% to 30% by weight, still more preferably 0.5% to 25% by weight or 2.0% to 25% by weight. The reducing sugar content can be calculated in terms of glucose content by the Somogyi-Schaffer method.

### <Other Components>

The lignin sulfonic acid component may include components other than the above-mentioned components. Examples of the other components may include an organic component and ash. Examples of the organic component may include low molecular weight organic substances (for example, an organic acid having 5 or fewer carbon atoms), such as formic acid, acetic acid, propionic acid, valeric acid, pyruvic acid, succinic acid, and lactic acid.

### <Weight Average Molecular Weight (RI)>

The weight average molecular weight (RI) of the lignin sulfonic acid component is preferably 3,000 or higher, more preferably 3,500 or higher, still more preferably 3,700 or higher, still more preferably 4,000 or higher. The upper limit of the weight average molecular weight (RI) is not particularly limited and is preferably 50,000 or lower, more preferably 40,000 or lower, still more preferably 35,000 or lower. Hence, the weight average molecular weight (RI) is preferably 3,000 to 50,000, more preferably 3,500 to 50,000, still more preferably 3,700 to 40,000, still more preferably 4,000 to 35,000. In the present specification, the weight average molecular weight (RI) is a weight average molecular weight determined by GPC using a refractive index detector (RI).

### <Weight Average Molecular Weight (UV)>

The weight average molecular weight (UV) of the lignin sulfonic acid component is preferably 9,000 or higher, more preferably 11,000 or higher, still more preferably 15,000 or higher, still more preferably 17,000 or higher. The upper limit of the weight average molecular weight (UV) is not particularly limited and is preferably 70,000 or lower, more preferably 60,000 or lower, still more preferably 57,000 or lower. Hence, the weight average molecular weight (UV) is preferably 9,000 to 70,000, more preferably 11,000 to 70,000, still more preferably 15,000 to 60,000, still more preferably 17,000 to 57,000. In the present specification, the weight average molecular weight (UV) is a weight average molecular weight determined by GPC using an ultraviolet-visible absorbance detector.

### —Ratio of Weight Average Molecular Weight RI/UV—

The ratio of the weight average molecular weight (RI) to the weight average molecular weight (UV) is preferably 0.95 or lower, and more preferably 0.93 or lower. The lower limit of the ratio is not particularly limited and is usually 0.4 or higher, preferably 0.5 or higher.

As the lignin sulfonic acid component, for example, a product having the above-mentioned content of the substituent and the inorganic component may be selected from SanLighon series (to be marketed by Nippon Paper Industries Co., Ltd. in and after July 2022) and used.

### <1.2 Method for Producing Lignin Sulfonic Acid Component>

Although a method for producing the lignin sulfonic acid component is not particularly limited, the lignin sulfonic acid component can be produced, for example, by sulfite treatment of a lignocellulosic raw material or by decomposing and thereby sulfonating lignin. By adjusting production conditions, the type and content of a substituent in the lignin sulfonic acid component and the type and content of each component, such as an inorganic component or reducing sugars, can be adjusted.

### —Raw Material—

The lignocellulosic raw material as one example of a raw material is not particularly limited as long as the lignocellulosic raw material includes lignocellulose in its composition. Examples of the lignocellulosic raw material may include pulp materials such as wood and non-wood. Examples of the wood may include: conifer wood, such as Pinus radiata, Yezo spruce, Japanese red pine, cedar, and cypress; and hardwood, such as white birch and beech. Any age and any part of the wood can be used. Therefore, woods collected from trees that are different in age or woods collected from different parts of a tree may be used in combination. Examples of the non-wood may include bamboo, kenaf, reed, and rice plant. These lignocellulose raw materials can be used alone or in combination of two or more.

Examples of lignin as another example of the raw material may include naturally occurring substances and artificially produced materials (for example, a dehydrogenation polymer of hydroxy cinnamyl alcohol analogue).

### —Sulfite Treatment—

Sulfite treatment can be performed by bringing at least one of sulfurous acid and sulfite salt into contact with the lignocellulosic raw material. Conditions for the sulfite treatment are not particularly limited as long as a sulfo group can be introduced into an α-carbon atom of a side chain of lignin included in the lignocellulosic raw material.

The sulfite treatment is preferably performed by sulfite cooking. Thus, lignin in the lignocellulosic raw material can be more quantitatively sulfonated. Sulfite cooking is a method in which the lignocellulosic raw material is subjected to a reaction at high temperature in a solution (for example, a water solution or a cooking liquid) of at least one of sulfurous acid and sulfite salt. The method is advantageous in terms of cost-effectiveness and ease of implementation because the method has been industrially established and practiced as a method for producing sulfite pulp.

Examples of the sulfite salt for performing sulfite cooking may include magnesium salts, calcium salts, sodium salts, and ammonium salts.

The concentration of sulfurous acid (SO₂) in a solution of at least one of sulfurous acid and sulfite salt is not particularly limited, but the ratio of the mass (g) of SO₂ with respect to 100 mL of a reaction chemical solution is preferably 1 g/100 mL or more, and, for performing sulfite cooking, the ratio thereof is more preferably 2 g/100 mL or more. The upper limit of the ratio is preferably 20 g/100 mL or less, and, for performing sulfite cooking, the upper limit thereof is more preferably 15 g/100 mL or less. The concentration of SO₂ is preferably 1 g/100 mL to 20 g/100 mL, and, for performing sulfite cooking, the concentration of SO₂ is more preferably 2 g/100 mL to 15 g/100 mL.

A pH value in the sulfite treatment is not particularly limited and is usually 10 or less. Sulfite cooking, if performed, is preferably performed under acidic conditions, more preferably at pH 5 or less, still more preferably at pH 3 or less. Thus, a lignin derivative (for example, lignin sulfonic acid) can be obtained more efficiently, which results in achievement of higher quality pulp. The lower limit of the pH value is preferably 0.1 or more, and, for performing sulfite cooking, the lower limit thereof is more preferably 0.5 or more. The pH value in the sulfite treatment is preferably 0.1 to 10, and, for performing sulfite cooking, the pH value is more preferably 0.5 to 5, still more preferably 0.5 to 3.

The temperature of the sulfite treatment is not particularly limited and is preferably 170° C. or lower, and, for performing sulfite cooking, the temperature is more preferably 150° C. or lower. The lower limit of the temperature of the sulfite treatment is preferably 70° C. or higher, and, for performing sulfite cooking, the lower limit thereof is more preferably 100° C. or higher. The temperature condition for the sulfite treatment is preferably 70° C. to 170° C., and, for performing sulfite cooking, the temperature condition is more preferably 100° C. to 150° C.

The time of the sulfite treatment is not particularly limited and depends on sulfite treatment conditions, but is preferably 0.5 to 24 hours, more preferably 1.0 to 12 hours.

In the sulfite treatment, a compound capable of providing a counter cation is preferably added to the lignin sulfonic acid. With the addition of the compound capable of providing a counter cation, the pH value in the sulfite treatment can be kept constant. Examples of the compound capable of providing a counter cation may include MgO, Mg(OH)₂, CaO, Ca(OH)₂, CaCO₃, NH₃, NH₄OH, NaOH, NaHCO₃, and Na₂CO₃. The counter cation is preferably a magnesium ion or a sodium ion.

When a solution of at least one of sulfurous acid and sulfite salt is used in the sulfite treatment, besides SO₂, the solution may include the above-mentioned counter cation (salt) and a cooking penetrating agent (for example, a cyclic ketone compound, such as anthraquinone sulfonate, anthraquinone, or tetrahydroanthraquinone) as necessary.

There is no limitation on equipment used for the sulfite treatment. For example, commonly known dissolving-pulp production equipment can be used.

Separation of an intermediate product from a solution of at least one of sulfurous acid and sulfite salt can be performed in accordance with a usual method. Examples of the separation method may include a method of separating a sulfite cooking waste liquid after sulfite cooking (for example, filtration).

The lignin sulfonic acid obtained by the sulfite treatment (for example, obtained as a filtrate or a filtration residue, preferably a filtrate, after the filtration of insoluble substances contained in a sulfurous acid solution) may be used as it is or concentrated as necessary and used as the lignin sulfonic acid component being an active ingredient. On the other hand, another treatment may be further performed as necessary. Thus, purity can be enhanced or other substituents not originally present in a raw material can be introduced. Examples of the other treatment may include alkaline treatment, oxidation treatment, dialysis treatment, ultrafiltration treatment, modification treatment, and combinations thereof.

### —Alkaline Treatment—

The alkaline treatment is beneficially such that a target sample is placed under alkaline conditions. Placing the target sample under alkaline conditions usually means placing the target sample under a water solution with a pH value of 8 or higher, preferably a pH value of 9 or higher. The upper limit of the pH value is usually 14.

In the alkaline treatment, an alkaline substance is usually brought into contact with a sulfite-treated material. The alkaline substance is not particularly limited and examples thereof may include calcium hydroxide, magnesium hydroxide, sodium hydroxide, potassium hydroxide, sodium carbonate, and ammonia. Among them, sodium hydroxide and calcium hydroxide are preferably used. The alkaline substances may be used alone or in combination with two or more.

Examples of a method for bringing the sulfite-treated material into contact with the alkaline substance may include a method in which a dispersion or a solution (for example, a water dispersion or a water solution) of the sulfite-treated material is prepared and the alkaline substance is added to the dispersion or the solution and a method in which a solution or a dispersion (for example, a water dispersion or a water solution) of the alkaline substance is added to the sulfite-treated material.

The temperature of the alkaline treatment is not particularly limited and is preferably 40° C. or higher, more preferably 60° C. or higher. The upper limit of the temperature of the alkaline treatment is preferably 150° C. or lower, more preferably 120° C. or lower, still more preferably 110° C. or lower.

The amount of the alkaline substance in the alkaline treatment is preferably 0.5% to 40% by mass, more preferably 1.0% to 30% by mass, with respect to the solid contents of the sulfite-treated material or with respect to the mass of a water solution or a dispersion obtained by dispersing an alkaline-treated extract in an aqueous solvent (for example, water).

The time of the alkaline treatment is not particularly limited and is preferably 0.1 hours or longer, more preferably 0.5 hours or longer. The upper limit of the time is preferably 10 hours or shorter, more preferably 6 hours or shorter.

Prior to the alkaline treatment, the dissolution, the dispersion treatment, and the concentration adjustment of the sulfite-treated material (the preparation of a solution of an aqueous solvent such as water or a dispersion) may be performed as necessary. The dispersion treatment can be performed, for example, by passing through a disc refiner, by addition to a mixer or a disperser, or by kneading treatment. The concentration adjustment can be performed, for example, using an aqueous solvent such as water.

### —Oxidation Treatment—

The oxidation treatment can be performed for a treated product obtained after the sulfite treatment (for example, a filtrate after filtration) or a treated product obtained after the alkaline treatment. The oxidation treatment is beneficially performed suitably using an oxidant. In the case of using an oxidant gas, the oxidation treatment can be performed by causing the gas to pass through a filtrate. In the case of using a liquid oxidant, the oxidation treatment can be performed by adding the liquid to a filtration residue or a filtrate. As the oxidant, air, oxygen, hydrogen peroxide, ozone, or a combination thereof is preferably used. The oxidation treatment is preferably performed under alkaline conditions (alkaline oxidation treatment). The pH for the alkaline oxidation treatment is usually 8 or more, preferably 10 or more, still more preferably 12 or more. The temperature of the oxidation treatment is usually 20° C. to 200° C., more preferably 50° C. to 180° C. The time of the oxidation treatment is usually 0.1 hours or longer, more preferably 0.5 hours or longer. The upper limit of the time is preferably 5 hours or shorter, more preferably 3 hours or shorter.

### —Dialysis Treatment or UF Treatment—

The dialysis treatment can be performed for a treated product obtained after the sulfite treatment (for example, a filtrate after filtration). Examples of a dialysis membrane may include: cellulose-based membranes, such as cellulose acetate; and synthetic polymer-based membranes, such as ethylene vinyl alcohol, polyacrylonitrile, polymethyl methacrylate, polysulfone, and polyethersulfone. The molecular weight cut-off of the dialysis membrane is usually 5,000 to 100,000, preferably 7,000 to 80,000, more preferably 10,000 to 50,000.

Instead of the dialysis treatment, ultrafiltration treatment (UF treatment) can be used. A known UF membrane can be used. Examples of the UF membrane may include a hollow-fiber membrane, a spiral membrane, a tubular membrane, and a flat membrane. Any known material for the UF membrane can be used. Examples of the material may include cellulose acetate, aromatic polyamide, polyvinyl alcohol, polysulfone, polyvinylidene fluoride, polyethylene, polyacrylonitrile, and ceramic. Note that the UF membrane may be a commercial product.

The molecular weight cut-off of the UF membrane is preferably 5,000 to 30,000, more preferably 10,000 to 25,000, still more preferably 15,000 to 23,000. The use of the UF membrane having a molecular weight cut-off of 5,000 or more can prevent the separation rate of a treatment liquid from becoming excessively slow. The use of the UF membrane having a molecular weight cut-off of 30,000 or less can prevent lignin from not being separated from a treatment liquid.

Any concentration rate resulting from the UF treatment using the UF membrane can be set. In other words, the UF treatment is beneficially stopped at the time when the outflow of a concentrated liquid reaches an arbitrary amount. Concentrating to 2 to 6 times is preferred. Concentrating to 2 to 6 times means that the amount of an undiluted solution (black liquor) is reduced to ½ to ⅙ of the initial amount.

The temperature of the treatment liquid during the UF treatment is not particularly limited. For example, the temperature is preferably 20° C. to 80° C., and is more preferably 20° C. to 70° C. from the viewpoint of the heat resistance of a UF membrane material. The pH value of the treatment liquid in the UF treatment is preferably 2 to 11. The solids concentration (w/w) of the black liquor in the UF treatment is preferably 2% to 30%, more preferably 5% to 20%.

Examples of the modification treatment may include: chemical modification methods, such as hydrolysis, alkylation, alkoxylation, sulfonation, sulfonic acid esterification, sulfomethylation, aminomethylation, desulfonation, alkalization, and a condensation reaction with (poly)alkylene oxide; and a molecular weight cut-off method by ultrafiltration of a lignin sulfonic acid. Among them, as the chemical modification method, one or two or more of reactions selected from hydrolysis, alkoxylation, desulfonation, alkylation, and a condensation reaction with (poly)alkylene oxide (for example, WO 2021/066166) are preferred.

### <1.3 Plant Growth Promotion Effect>

The lignin sulfonic acid component has the effect of promoting plant growth.

### <Plant>

Examples of a target plant may include an herbaceous plant and a woody plant. Examples of the herbaceous plant may include Cruciferae, Leguminosae, Cucurbitaceae, Solanaceae, Capsicum annum, Rosaceae, Malvaceae, Poaceae, Allium, Amaryllidaceae, Compositae, Amaranthaceae, Umbelliferae, Zingiberaceae, Labiatae, Araceae, Convolvulaceae, Dioscoreaceae, and Nelumbonaceae. Specific examples of the herbaceous plant may include: green vegetables, such as Brassica campestris var. komatsuna (Japanese mustard spinach), Chinese cabbage, onion, leek, garlic, Allium chinense, Allium tuberosum, Cruciferae, bok choy, cabbage, cauliflower, broccoli, Brussels sprouts, asparagus, lettuce, salad greens, celery, spinach, garland chrysanthemum, parsley, Japanese hornwort, Oenanthe javanica, Aralia cordata, Zingiber mioga, Japanese butterbur, and Perilla frutescens var. crispa; fruit vegetables, such as soybean, green soybean, broad bean, pea, cucumber, eggplant, melon, corn, pumpkin, watermelon, tomato, green pepper, strawberry, okra, and string green bean; root vegetables, such as carrot, turnip, radish, burdock, potato, taro, sweet potato, Japanese yam, ginger, and lotus root; Poaceae (for example, paddy rice, upland rice); wheats (for example, wheat, barley); and flowers and ornamental plants. Examples of the woody plant may include: Cryptomeria japonica (for example, Japanese cedar), Chamaecyparis obtusa (for example, Japanese cypress), Pinaceae (Pinus (for example, Pinus thunbergii), Larix (for example, Larix leptolepis, Larix gmelini), Abies (for example, Abies sachalinensis)), Eucalyptus (for example, Eucalyptus globulus), Prunus (for example, cherry tree, plum, and Prunus tomentosa), Mangifera indica (for example, mango), Acacia, Myrica rubra, Quercus acutissima (for example, sawtooth oak), Grape, Apple, Rosa, Camellia (for example, Thea sinensis), Jacaranda (for example, jacaranda), Persea americana (for example, avocado), Pyrus spp. (for example, pear), Santalaceae (for example, Santalum album (sandalwood)). Among them, herbaceous plants are preferred, and cruciferous and leguminous plants are more preferred.

Examples of plant growth promotion may include an increase in growth amount (increased growth rate), proliferation of a plant body (or a part of a plant body such as a fruit or a root), germination promotion, differentiation promotion (for example, tissue culture such as cutting and scion), an increase in the content of an inorganic component (such as magnesium, phosphorus, potassium, or calcium), and quality improvement such as improvement of eating-quality of an edible part. In the case of green vegetables, the plant growth promotion can be confirmed by measuring a germination rate, an SPAD value, a root growth amount, a head formation rate, head weight, and outer leaf size. In the case of fruit vegetables whose edible parts are seeds (such as soybeans, green soybeans, broad beans), the plant growth promotion can be confirmed by measuring the plant height, grain weight, thousand-kernel weight, and the like.

### <1.4 Biostimulant>

The lignin sulfonic acid component is capable of improving the physiological state of plants and soil and promoting healthy growth by utilizing natural power with which plants and their surrounding environments are naturally equipped, and, as a result, the yield and quality of plants and the yield and quality of crops can be enhanced, and furthermore, it can be expected that stress tolerance is given to plants and storage stability of crops after harvest is provided, and hence, the lignin sulfonic acid component can be used as a biostimulant. When the lignin sulfonic acid component is used as a biostimulant, target plants are the same as those mentioned in the description about the plant growth promoter.

### <1.5 Optional Component>

Each of the above-mentioned agents (the plant growth promoter and the biostimulant) may include a component (an optional component) other than the lignin sulfonic acid component as necessary. Examples of the optional component may include optional components (formulation aids), such as a plant growth promoting component other than the lignin sulfonic acid component, a biostimulant other than the lignin sulfonic acid component, an excipient, a colorant, a preservative, a pH regulator, a stabilizer, a disintegrator, a carrier, a binder, a pH adjuster, a defoaming agent, a nonionic surfactant, a cationic surfactant, and an amphoteric surfactant.

Examples of the plant growth promoting component may include components that can supply plant nutrients, such as an inorganic component, silver ions, an antioxidant, a carbon source, vitamins, amino acids, and phytohormones. The form of the additives is not particularly limited and the additives may be in the form of a solid (such as powder or granules) or a liquid (such as a liquid fertilizer).

Examples of the inorganic component may include: inorganic salts, such as nitrogen, phosphorus, and potassium as essential elements, and sulfur, calcium, magnesium, iron, manganese, zinc, boron, molybdenum, chlorine, iodine, and cobalt as micronutrients; and oxides, chlorides, sulfates, hydroxides, and carbonates thereof. Specific examples of the inorganic component may include magnesium hydroxide, magnesium oxide, calcium carbonate (slaked lime), potassium nitrate, ammonium nitrate, ammonium chloride, sodium nitrate, monoammonium phosphate, potassium monohydrogen phosphate, sodium dihydrogen phosphate, potassium oxide, potassium chloride, potassium sulfate, ammonium sulfate, magnesium sulfate, calcium sulfate, ferrous sulfate, ferric sulfate, manganese sulfate, zinc sulfate, copper sulfate, sodium sulfate, calcium chloride, magnesium chloride, cobalt chloride, boric acid, molybdenum trioxide, sodium molybdate, potassium iodide, calcium phosphate monobasic, mixtures thereof (for example, calcium superphosphate (a mixture of calcium phosphate monobasic and calcium sulfate), soluble phosphate (a mixture of soluble phosphoric acid, lime, magnesium (magnesia), and the like), RINSHOANKARI (a mixture of ammonium nitrate, potassium sulfate, monoammonium phosphate, and the like), and hydrates thereof.

Examples of the antioxidant may include ascorbic acid and sulfite salt, and ascorbic acid is preferred. Ascorbic acid is low persistent in a planting medium, and accordingly environmental contamination can be reduced.

Examples of the carbon source may include compounds, such as carbohydrates such as sucrose and derivatives thereof; organic acids such as fatty acids; and primary alcohols such as ethanol.

Examples of the vitamins may include biotin, thiamine (vitamin B1), pyridoxine (vitamin B4), pyridoxal, pyridoxamine, calcium pantothenate, inositol, nicotinic acid, nicotinamide, and riboflavin (vitamin B2).

Examples of the amino acids may include glycine, alanine, glutamic acid, cysteine, phenylalanine, and lysine.

Other examples may include inorganic components, organic materials (for example, humic substances, such as compost, oil cake, and humic acid), and microbial materials (for example, yeast). The optional components may be used alone or in combination of two or more.

A fertilizer component may be a fast-release fertilizer, a slow-release fertilizer, or a delayed-release fertilizer, and may be any of an inorganic fertilizer, an organic fertilizer, or a compound fertilizer.

Examples of the other biostimulants may include biologically derived materials (for example, humic acid, organic acid such as fulvic acid, humus; seaweed; microorganisms, such as Trichoderma, mycorrhiza, yeast, Bacillus subtilis, and root nodule bacteria: plants and animals; and metabolites thereof), extractive seaweed-derived materials (seaweed and extracts thereof), saccharides (for example, polysaccharides), peptides (including amino acids), minerals (the same minerals as those in the examples above), and vitamins (the same vitamins as those in the examples above).

Regarding the amount of optional components contained, an appropriate amount is selected for each optional component.

### <1.6 Formulation, Production Method>

The formulation of each of the above-mentioned agents (the plant growth promoter and the biostimulant) is not particularly limited, and examples thereof may include powder, microgranular, granular, and liquid formulations. A microgranular or granular formulation can lead to the easiness of spraying. A liquid formulation can lead to easiness of mixing with a functional component and thereby lead to stabilization of a slurry after the mixing. Each agent may be formulated together with a functional component or may be separately formulated. A proper method for producing each agent can be selected as appropriate in accordance with formulations.

### <2. Plant Production Method>

The plant growth promoter and the biostimulant described above can be used for plant production. Thus, plant growth can be promoted, which can lead to increased production of crops. Target plants are the same as the above-mentioned examples of the target plants.

### <Conditions for Use>

Conditions for use of each of the above-mentioned agents (the plant growth promoter and the biostimulant) are not particularly limited. One example is a method of administering the agent to a support used for plant production and/or a plant body (for example, leaves or stems). Examples of the support may include natural soils, such as sand and soil; artificial soils, such as rice husk charcoal, coconut fiber, vermiculite, perlite, peat moss, glass beads, and rice husks; porous moldings, such as foamed phenolic resin and rock wool; solidifying agents (for example, agar and gellan gum), a combination of two or more of them. Although a method of administration depends on formulation, the type of the support, examples of the method may include spraying and application (the agent may be mixed with water and sprayed during irrigation), and, in addition, mixing treatment such as stirring may be performed if needed. The timing of administration of the plant growth promoter according to the present invention is not particularly limited, and the plant growth promoter may be administered to the support before use or may be added once or multiple times after the start of growth from a seedling or a seed of a plant body, or both the administration and the addition may be performed. The amount of the plant growth promoter according to the present invention administrated may be appropriately determined in accordance with a plant species, addition timing, cultivation conditions, and the like, and is usually 0.000001% by weight or more, preferably 0.00001% by weight or more, more preferably 0.00005% by weight or more per support (for example, planting soil) in terms of the lignin sulfonic acid component. The upper limit of the amount of the administration is not particularly limited and is usually 10% by weight or less.

The plant growth promoter or the biostimulant may be used in combination with another plant growth promoter or another biostimulant. In the case of using in combination, the plant growth promoter or the biostimulant may be mixed with the other agent and administered simultaneously, or the agents may be administered separately at their respective appropriate timings. Examples of the other agent can include the above-mentioned examples of the fertilizer.

In plant production using the plant growth promoter or the biostimulant, plant cultivation conditions (such as temperature, light intensity, light type (for example, artificial light, sunlight), light-intensity cycle, irrigation amount, humidity, carbon dioxide concentration, with or without the adjustment of them, seeding density, irrigation method, irrigation amount, the presence or absence of cultivation facilities and containers (for example, a planter, a pot, a vat, a container, a cell tray)) are not particularly limited and can be suitably selected.

### <3. Plant Cultivation Kit>

The plant growth promoter or the biostimulant may constitute a plant cultivation kit, together with a seed or a seedling of a plant. Examples of a target plant can include the above-mentioned examples of the target plant. Depending on a plant species, a seed or a seedling is selected. The plant cultivation kit may further include a support and a container. Examples of the support and the container can include the above-mentioned examples of the support and the container.

### EXAMPLE

Hereinafter, the present invention will be described using examples. The following examples are not intended to limit the present invention.

Compositions of main samples used in the examples are illustrated in Table 1.

TABLE 1
Main samples used in Examples

| | | | | | Sample 5 | | |
|---|---|---|---|---|---|---|---|
| | | Sample 2 | | | alkali | | |
| | | lignin | | | extracted | Sample 6 | |
| | | sulfonic | Sample 3 | | lignin | AZUMIN | Sample 7 |
| | Sample 1 | acid | lignin sulfonic | | (soda | (manufactured | lignin |
| | lignin | (reducing- | acid (Na type, | Sample 4 | digestion | by | sulfonic |
| | sulfonic | sugars | high-purity | kraft | black | Denka | acid (Ca |
| Examples | acid | reduced) | lignin) | lignin | liquor) | Co. Ltd) | type) |
| phenolic hydroxyl | 1.24 | 1.75 | 2.52 | 4.78 | 3.89 | 0.43 | 1.26 |
| group *² [%] *¹ | | | | | | | |
| carboxyl group *³ | 1.25 | 2.44 | 0.53 | 1.34 | 4.88 | 2.22 | 1.31 |
| [mmol/g] | | | | | | | |
| reducing sugars*⁴ [%] *¹ | 21.60 | 7.06 | 0.95 | 1.85 | 1.88 | 0.73 | 22.19 |
| OCH₃*⁵ [%] *¹ | 6.52 | 7.83 | 11.21 | 11.55 | 13.39 | 0.16 | 6.82 |
| S*⁶ [%] *¹ | 7.81 | 6.69 | 7.12 | 1.89 | 0.78 | 0.04 | 5.45 |
| SO₃*⁷ [%] *¹ | 0.19 | 0.05 | 0.02 | 0.01 | 0.03 | ND | 0.59 |
| SO₄*⁷ [%] *¹ | 8.24 | 4.32 | 1.00 | 1.33 | 1.09 | 0.21 | 1.50 |
| sulfone group S*⁸ [%] *¹ | 5.0 | 5.23 | 6.8 | 1.25 | 0.39 | 0.03 | 4.82 |
| molecular weight | 4,100 | 4,700 | 12,900 | 1,300 | 1,900 | 4,400 | 4,500 |
| Mw (RI) *⁹ | | | | | | | |
| molecular weight | 7,000 | 7,800 | 14,300 | 1,400 | 1,900 | 5,000 | 7,500 |
| Mw (UV) *¹⁰ | | | | | | | |
| Ca*¹¹ [%] *¹ | 0.43 | 0.88 | 0.04 | 0.01 | 0.02 | 1.09 | 2.31 |
| Na*¹¹ [%] *¹ | 1.2 | 1.66 | 6.1 | 0.05 | 0.74 | 0.03 | 0.55 |
| Mg*¹¹ [%] *¹ | 3.8 | 3.7 | 0.2 | 0.4 | 0.01 | 3.11 | 0.97 |

### <Footnotes to Table 1>

*1 “%” represents percent by mass of the dry weight of a sample.
*2 Phenolic hydroxyl group content

From the absorption spectrum of an alkaline solution including a lignin sample, the absorption spectrum of a neutral solution including lignin with the same concentration was subtracted to obtain an ionization differential spectrum, and the phenolic hydroxyl group content (%) was determined using the following formula. In the formula, Δαmax [L/(g·cm)] represents a differential absorption coefficient (Nakano Junzo (ed.), “Chemistry of Lignin—Basics and Applications—enlarged and revised edition” (Lignin no kagaku -kiso to ohyo- (in Japanese)), Uni Press, May 25, 1990, p. 541).

$$Phenolic hydroxyl group content ( \% ) = ( 17 \times Δα max ) / 4100 \times 100$$

*3 Carboxyl group content

60 ml of 0.5% by mass of a water dispersion of a sample was prepared, and a 0.1 M hydrochloric acid aqueous solution was added thereto to adjust to pH 2.5. Subsequently, a 0.05 N sodium hydroxide aqueous solution was added dropwise and an electrical conductivity was measured until the pH reached 11. From the amount (a) of sodium hydroxide consumed during the neutralization of weak acid with a slow change in electrical conductivity, the carboxyl group content was calculated using the following formula:

$$carboxyl group content [ mmol / g sample ] = a [ ml ] \times 0.05 / mass of sample$$

*4 Reducing sugar content

The reducing sugar content of a lignin fertilizer was calculated by converting a value measured by the Somogyi-Schaffer method into a glucose content.
*5 Methoxyl (OCH₃) group content

The methoxyl group content of lignin was determined by the method of quantitative determination of methoxyl groups in accordance with the Viebock and Schwappach method (“Lignin Chemistry Methodology” (lignin kagaku kenkyuho (in Japanese)), Uni Press, 1994, pp. 336-340).
*6 Total sulfur atom(S) content

The S content was determined by ICP emission spectrometry.
*7 Sulfur oxide (SO₃, SO₄) content

SO₃ content and SO₄ content were each determined by ion chromatography.
*8 Sulfur atom(S) content of sulfone group

The S content of a sulfone group was determined by the following formula.

$$S content of sulfone group ( \% by mass ) = S content ( \% by mass ) - inorganic form S content ( \% by mass )$$

In the formula, percent by mass represents a ratio of the S content to the solids content of lignin sulfonic acid.

The S content is a value measured by the method described above. The inorganic form S content represents the total amount of the SO₃ content and the SO₄ content determined by the method described above.
*9 Weight average molecular weight (RI)

The weight average molecular weight (RI) was determined by gel permeation chromatography (GPC) under the following conditions.

Measuring device: manufactured by Tosoh Corporation

Columns used: Shodex Column OH-pak SB-806HQ, SB-804HQ, SB-802.5HQ

Eluent: 0.05 mM sodium nitrate/acetonitrile 8/2 (v/v)

Reference material: polyethylene glycol (manufactured by Tosoh Corporation or GL Sciences Inc.)

Detector: Differential refractometer (manufactured by Tosoh Corporation)

Calibration curve: polyethylene glycol standard
*10 Weight average molecular weight (UV)

The weight average molecular weight (UV) was determined under the same conditions as for the weight average molecular weight (RI) by the above-described RI detection, except that a UV detector (280 nm, manufactured by Tosoh Corporation) was used as a detector.
*11 Ca content, Na content, Mg content

Metal ions (Ca²⁺, Na⁺, and Mg²⁺) were quantitatively determined by the inductively coupled plasma (ICP) method, and quantitative determination results were converted into a Ca content, a Na content, and a Mg content (% by mass).

### Production Example 1: Production of Sample 1

Wood (radiata pine) was subjected to sulfite treatment based on sulfite cooking, whereby an intermediate composition was obtained. The sulfite treatment was performed using a magnesium sulfite solution having a SO₂ concentration of 4 g/100 mL at a temperature of 140° C. and pH 2 for a treatment time of 3 hours. Subsequently, insoluble substances were filtered off and the resulting filtrate was concentrated by a rotary evaporator until the solids content reached 50%, whereby an intermediate composition A was obtained. The intermediate composition A was subjected to spray-drying, whereby sample 1 as a solidified composition was obtained.

### Production Example 2: Production of Sample 2

The intermediate composition A obtained in Production Example 1 was subjected to an alkaline reaction (the addition rate of a calcium hydroxide solution: 9 wt % (with respect to solid contents), reaction temperature: 90° C., reaction time: 4 hours) and an oxidation reaction (treatment with oxygen, oxygen pressure: 200 kPa, reaction time: 2 hours), and the pH of the resulting intermediate composition A was adjusted to 7.0. The resulting intermediate composition A was subjected to spray-drying, whereby a solidified composition, namely, sample 2 was obtained.

### Production Example 3: Production of Sample 3

Wood (radiata pine) was subjected to sulfite treatment based on sulfite cooking, whereby an intermediate composition was obtained. The sulfite treatment was performed using a sodium sulfite solution having a SO₂ concentration of 4 g/100 mL at a temperature of 140° C. and pH 2 for a treatment time of 3 hours. Subsequently, insoluble substances were filtered off, and the pH of the resulting filtrate was adjusted to 5.0. The resulting filtrate was subjected to ultrafiltration using a polysulfone-based ultrafiltration membrane having a molecular weight cut-off of 20,000, and the resulting concentrated liquid was spray-dried, whereby a solidified composition, namely, sample 3, was obtained.

### Production Example 4: Production of Sample 4

A lignin-containing material (kraft lignin) was prepared from a kraft cooking black liquor in accordance with the usual method.

3 kg of a coniferous kraft cooking black liquor was put into a beaker. While the black liquor was kept warm at 60° C. and stirred, carbon dioxide was blown in under atmospheric pressure until the pH reached 10. Subsequently, the black liquor was kept stirred at 80° C. for 1 hour to produce a precipitate 3, and then dehydrated by filtration, whereby a carbonate lignin cake was obtained.

The obtained carbonate lignin cake was transferred to a beaker, and pure water was added thereto so as to achieve a solids concentration of 15% by mass, and the mixture was stirred to make a homogeneous slurry. The slurry was kept warm at 50° C., and, while the slurry was stirred, 8 N sulfuric acid was added thereto until the pH of the slurry reached 2. Subsequently, the slurry was stirred at 50° C. for 1 hour to produce a precipitate 4. The slurry was filtered through a Buchner funnel to obtain a lignin cake (precipitate 4). To the lignin cake, 100 ml of warm water of 50° C. was added, and filtration and washing were repeated until the electrical conductivity of the filtrate reached 0.2 S/m or lower, whereby a lignin-containing material was obtained. The obtained lignin-containing material was dried by a blast dryer at 50° C. (solids concentration: 95% by mass).

### Production Example 5: Production of Sample 5

A lignin-containing material (soda lignin) was prepared from a soda cooking black liquor in accordance with the usual method.

200 ml of a soda AQ cooking black liquor of rice straw was put into a beaker. While the black liquor was kept warm at 70° C. and stirred, carbon dioxide was blown in under atmospheric pressure until the pH reached 8. Subsequently, the black liquor was kept stirred at 70° C. for 1 hour to produce a precipitate 1, and then dehydrated by filtration, whereby a carbonate lignin cake (precipitate 1) was obtained.

The obtained carbonate lignin cake was transferred to a beaker, and pure water was added thereto so as to achieve a solids concentration of 15% by mass, and the mixture was stirred to make a homogeneous slurry. The slurry was kept warm at 50° C., and, while the slurry was stirred, 8 N sulfuric acid was added thereto until the pH of the slurry reached 2. Subsequently, the slurry was stirred at 50° C. for 1 hour to produce a precipitate 2. The slurry was filtered through a Buchner funnel to obtain a lignin cake (precipitate 2). To the lignin cake, 100 ml of warm water of 50° C. was added, and filtration and washing were repeated until the electrical conductivity of the filtrate reached 0.5 S/m or lower, whereby a lignin-containing material was obtained. The obtained lignin-containing material was dried by a blast dryer at 50° C. (solids concentration: 95% by mass).

### Test Example 1: Cultivation Test of Komatsuna (Japanese Mustard Spinach)

### (1) Cultivation by Sunlight (Examples 1 to 2 and Comparative Examples 1 to 3)

Brassica campestris var. komatsuna (Atalya Farm, komatsuna) was sown on Aug. 23, 2021. The sowing interval was 250 seeds/m² and the number of seeds per pot (size: 7 L, dimensions 450 mm×208 mm×170 mm) was 20. Planting soil was prepared by spraying each of the samples listed in Table 2 and other fertilizers on 5 L of soil (“Soil for Flower and Vegetable Planters: Potting Mix” (Hana-yasai puranta-no-tsuchi puranta-baiyodo (in Japanese), produced by TACHIKAWA HEIWA NOUEN CO., LTD.: akadama soil, vermiculite, and bark compost) and mixing them. The plants were cultivated in the pots placed inside a room with a skylight window. During cultivation, the skylight window was opened to allow sunlight to enter. The skylight window was covered with a window screen to block direct sunlight. The temperature of the room was equivalent to the outside temperature. Watering was performed at the time when a soil surface of the Blank became dry (approximately once every 1 to 2 days). An equal amount of water was supplied each watering by using a shower nozzle, while care was taken so as to keep the soil sufficiently moist and so as to prevent leaves from being directly hit by a water and thereby falling over.

In each plot, four plants were selected from plants germinated on the 14th day of cultivation. On the 28th day of cultivation, SPAD values (Spoil Plant Analysis Development) of leaves selected from a portion near the stem apex of each plant were measured as an indication of chlorophyll content by using a chlorophyll meter SPAD-502, manufactured by KONICA MINOLTA, INC., and the average was calculated (N=10). On the 42nd day of cultivation, root spreading (the state of roots spreading in all directions underground) of the plants (N=4) was visually observed, and evaluation was performed using average plants under the following criteria: ++ very good root-spreading, compared to a plant grown without additives, + good root-spreading, compared to the plant grown without additives, + root-spreading equivalent to that of the plant grown without additives, − poor root-spreading, compared to the plant grown without additives (Table 2). Yield conversion was performed in comparison with a no-additive plot (Table 2).

### (2) Cultivation by Artificial Light (Examples 3 to 6 and Comparative Examples 4 to 10)

On Feb. 25, 2022, planting soil was prepared and komatsuna was sown in the same manner as in the test (1), except that samples illustrated in Table 3 were used. The plants were grown in the pots placed indoors near a window. The temperature was set at a temperature of 20° C. and the plants were irradiated with light by using a clip lamp for plant growth that is manufactured by Fujikura Co., Ltd. in a light intensity cycle including 9 hours as a light period and 14 hours as a dark period.

For each plot, the number of seeds germinated on the 14th day of cultivation (per 20 seeds) was counted. On the 28th day of cultivation, SPAD (Spoil Plant Analysis Development) values of ten leaves selected from a portion near the stem apex of each plant were measured as an indication of chlorophyll content by using a chlorophyll meter SPAD-502 manufactured by KONICA MINOLTA, INC., and the average was calculated (N=10). On the 28th day of cultivation, root spreading of the plants (N=4) was visually observed and evaluated using the same criteria as in the test (1) (Table 3).

TABLE 2
Cultivation test of komatsuna by sunlight (5 L of soil)

| | | | | amount of element in | | | | | | | |
|---|---|---|---|---|---|---|---|---|---|---|---|
| | | amount | | sample (already | | | | | | | |
| | | of | | analyzed) | | | | | | | |
| | | sample | | phosphorus | | nitrogen | | potassium | | SPAD (28 | root- |
| No. | Sample used | added | | P*¹ | | N*¹ | | K*¹ | | days) | spreading |
| Comparative | not added | — | | — | | — | | — | | 37.7 | ± |
| Example | (standard | | | | | | | | | | |
| 1 | plot) | | | | | | | | | | |
| Comparative | commercial | 8.79 | g | 0.879 | g | 0.879 | g | 0.879 | g | 39.9 | + |

| Example | fertilizer *² | | | | | | | | | |
|---|---|---|---|---|---|---|---|---|---|---|
| 2 | | | | | | | | | | |
| Example | sample 1 | 10 | g | — | | 0.019 | g | — | 43.6 | ++ |
| 1 | | | | | | | | | | |
| Comparative | yeast*³ | 10 | g | 0.126 | g | 0.879 | g | — | 41.7 | + |
| Example | | | | | | | | | | |
| 3 | | | | | | | | | | |
| Example | yeast*³ + | 19.78 | g | 0.123 | g | 0.879 | g | — | 42.5 | ++ |

| | |
|---|---|
| 2 | sample 1*⁴ |

TABLE 3
Cultivation test of komatsuna by artificial light

| | | | amount of element in | | | | | |
|---|---|---|---|---|---|---|---|---|
| | | | sample(g) (already | | | germination | | |
| | | amount | analyzed) | | | on 14th day | | |
| | Sample | of sample | phosphorus | nitrogen | potassium | of cultivation | SPAD(28 | |
| No. | used | added(g) | P*¹ | N*¹ | K*¹ | (/20)) | days) | root-spreading |
| Compar. | not added | | — | — | — | 15 | 37.4 | ± |
| Ex. 4 | (standard | | | | | | | |
| | plot) | | | | | | | |
| Compar. | commercial | 8.79 | 0.879 | 0.879 | 0.879 | 15 | 38.9 | + |
| Ex. 5 | fertilizer*² | | | | | | | |
| Compar. | sample 4 | 10 | — | — | — | 16 | 38.1 | + |
| Ex. 6 | | | | | | | | |
| Ex. 3 | sample 1 | 10 | — | 0.019 | — | 18 | 42.7 | ++ |
| Ex. 4 | sample 2 | 10 | — | — | — | 18 | 38.0 | ++ |
| Ex. 5 | sample 3 | 10 | — | — | — | 16 | 38.2 | ++ |
| Compar. | sample 5 | 10 | — | — | — | 14 | 37.8 | + |
| Ex. 7 | | | | | | | | |
| Compar. | sample 6 | 10 | — | — | — | 15 | 37.5 | + |
| Ex. 8 | | | | | | | | |
| Compar. | yeast*³ | 10 | 0.126 | 0.879 | — | 19 | 40.6 | + |
| Ex. 9 | | | | | | | | |
| Ex. 6 | yeast*³ + | 19.78 | 0.123 | 0.879 | — | 15 | 43.7 | ++ |
| | sample 1*⁴ | | | | | | | |
| Compar. | yeast*³ + | 19.78 | —*⁴ | 0.879 | — | 8 | 41.9 | + |
| Ex. 10 | sample 5*⁵ | | | | | | | |

### <Footnotes to Tables 2 and 3>

*1 The amount of each of elements, namely, phosphorus, nitrogen, and potassium is percentage by weight with respect to a sample added to planting soil.
*2 In Comparative Examples 2 and 5, Hachipara-Ace (a slow-release fertilizer, P10, N10, K10, magnesia 1), manufactured by NAKASHIMA TRADING CO., LTD., was used as a commercially-available fertilizer.
*3 In Comparative Examples 3, 9, and 10 and Examples 2 and 6, yeast (Kabi-torula, manufactured by Nippon Paper Industries Co., Ltd.) was used.
*4 In Examples 2 and 6, a ratio (weight ratio) of yeast:sample 1=9.78:10 was used to match with the commercial fertilizer in terms of nitrogen content.
*5 In Comparative Example 10, a ratio (weight ratio) of yeast:lignin=9.78:10 was used to match with Example 6 in terms of addition amount.

In both the sunlight cultivation test and the artificial light cultivation test, root-spreading in Examples was better than that in Comparative Examples. All the Examples exhibited high SPAD values (Tables 2 and 3).

### Test Example 2: Cultivation Test of Chinese Cabbage (Examples 7 to 9 and Comparative Examples 11 to 15)

On August 19, 3 seeds of Chinese cabbage (variety: Matsushima New No. 2) were sown per pot (size: 1/2000a=0.05 m², a Wagner pot (1/2000a), manufactured by Tokyo Garasu Kikai Co., Ltd.) placed in an open field. Planting soil was prepared by spraying the samples listed in Table 4 and other fertilizers on soil (alluvial sandy loam) and mixing them. Cultivation was performed outdoors.

In each plot, harvesting was performed on November 20 of the same year. Yield, the amount of MgO contained in Chinese cabbage, head weight, outer leaves, and head formation rate were measured, and an index for each of the measured values was calculated when a case having no sample added (Comparative Example 11) was taken as 100 (Table 5).

TABLE 4
Chinese cabbage growth test (amount of sample added per pot, unit: g)

| | | | Humisol | lignin | AZUMIN | Mg | |
|---|---|---|---|---|---|---|---|
| | Sample used | MgO*¹ | Mg | Mg | Mg | (OH)₂ | compost |
| Compar. | not added | 0 | 0 | 0 | 0 | 0 | 0 |
| Ex. 11 | (standard | | | | | | |
| | plot) | | | | | | |
| Compar. | Humisol Mg | 0.6 | 10 | 0 | 0 | 0 | 0 |
| Ex. 12 | | | | | | | |
| Ex. 7 | sample 2 | 0.6 | 0 | 12 | 0 | 0 | 0 |
| | lignin Mg | | | | | | |
| Compar. | sample 6 | 0.6 | 0 | 0 | 20 | 0 | 0 |
| Ex. 13 | AZUMIN Mg | | | | | | |
| Compar. | Mg (OH)₂ | 0.6 | 0 | 0 | 0 | 0.87 | 0 |
| Ex. 14 | | | | | | | |
| Ex. 8 | Mixture of | 0.6 | 5 | 6 | 0 | 0 | 0 |
| | Humisol Mg + | | | | | | |
| | lignin Mg | | | | | | |
| | (sample 2) + | | | | | | |
| | compost | | | | | | |
| Ex. 9 | lignin Mg | 0.6 | 0 | 24 | 0 | 0 | 0 |
| | (sample 2) | | | | | | |
| | in double | | | | | | |
| | amount + | | | | | | |
| | compost | | | | | | |
| Compar. | compost | 0 | 0 | 0 | 0 | 0 | 200 |
| Ex. 15 | | | | | | | |

### <Footnotes to Table 4>

*1 MgO represents the amount of MgO contained in each sample and was measured by the following method: 2.5 to 5 g of a sample to be analyzed was accurately weighed and put into a tall beaker, and approximately 30 ml of hydrochloric acid and approximately 10 ml of nitric acid were added thereto. The mixture was boiled for approximately 30 minutes and allowed to cool, and then water was added thereto to prepare accurately 250 to 500 ml of a solution. The solution was filtered through dry filter paper. A predetermined amount (preferably, 50 to 500 μg of Mg or 80 to 800 μg of MgO) of the resulting sample solution was accurately weighed and put into a 100 ml volumetric flask, and 10 ml of an interference inhibitor solution (60.9 to 152.1 g of strontium chloride (SrCl₂·6H₂O) was dissolved in 420 ml of HCl and water to prepare a 1000 ml solution. Alternatively, lanthanum chloride (53.5 g of LaCl₃·7H₂O was used) was added instead of strontium chloride, and then water was added up to a marked line, and absorbance was measured at a wavelength of 285.2 nm by an atomic absorption spectrochemical analyser. The amount of magnesium (Mg) or magnesium oxide (magnesia) (MgO) was determined from a calibration curve produced by accurately taking several levels of standard magnesium solutions at the same time and adding an interference inhibitor solution to each of the standard magnesium solutions so as to achieve the same concentration as that of the sample solution and performing photometric measurements under the same conditions.

TABLE 5
Chinese cabbage growth test (result)

| | | | | head | | | | outer | | head | |
|---|---|---|---|---|---|---|---|---|---|---|---|
| | | | | weight | | MgO | | leaf | | formation | |
| | Sample used | yield | index | (g) *¹ | index | (mg) *² | index | (cm) *³ | index | rate(%) *⁴ | index |
| Compar. | not added | 320.0 | 1.00 | 243.3 | 100 | 36 | 100 | 76.7 | 100 | 76.0 | 100 |
| Ex. 11 | (standard plot) | | | | | | | | | | |
| Compar. | Humisol Mg | 413.3 | 129 | 308.3 | 127 | 74 | 206 | 103.3 | 135 | 74.6 | 98 |
| Ex. 12 | | | | | | | | | | | |
| Ex. 7 | sample 2 | 490.0 | 153 | 397.5 | 163 | 91 | 253 | 92.5 | 121 | 81.1 | 107 |
| | lignin Mg | | | | | | | | | | |
| Compar. | sample 6 | 152.5 | 48 | 92.5 | 38 | 28 | 78 | 60.0 | 78 | 60.7 | 80 |
| Ex. 13 | AZUMIN Ng | | | | | | | | | | |
| Compar. | Mg (OH)₂ | 190.0 | 59 | 126.7 | 52 | 19 | 53 | 63.3 | 83 | 66.7 | 88 |
| Ex. 14 | | | | | | | | | | | |
| Ex. 8 | Humisol Mg + | 295.0 | 92 | 175.0 | 72 | 62 | 172 | 120.0 | 156 | 59.3 | 78 |
| | sample 2 | | | | | | | | | | |
| Ex. 9 | double-amount-of- | 401.7 | 126 | 280.0 | 115 | 125 | 347 | 121.7 | 159 | 69.7 | 92 |
| | sample 2 | | | | | | | | | | |
| Compar. | compost | 386.7 | 121 | 298.3 | 118 | 109 | 303 | 98.3 | 128 | 74.6 | 98 |
| Ex. 15 | | | | | | | | | | | |

### <Footnotes to Table 5>

*1 Head weight (g) represents the average weight of Chinese cabbage having headed.
*2 MgO (unit: mg) represents the MgO content (%) of Chinese cabbage and was measured by the following method: in a farm field, 10 to 20 plants having an average size were selected and collected. 8 to 10 pieces of large-sized or medium-sized plants were collected and each was divided vertically into 4 to 8 sections, and one of the sections was taken. Approximately 20 pieces of small-sized plants were collected. Subsequently, leaves of the plants were stripped and spread out and subjected to ventilation-drying. The leaves were divided into inner and outer leaves as needed. After drying, the leaves were pulverized by a Wiley mil or a coffee mill to obtain powder samples, and the powder samples were measured in the same manner as the above-described MgO measurement method.
*3 Outer leaf (cm) represents the maximum leaf length of outer leaves (N=3).
*4 Head formation rate (%) represents the percentage of plants having headed with respect to the total number of plants.

Examples 7 to 9 each had a higher MgO content and larger outer leaves than Comparative Examples. Among them, Examples 7 and 9 exhibited good yield and head weight, and Example 7 had a high head formation rate (Table 5).

### <Test Example 3: Cultivation Test of Soybean (Examples 10 to 13 and Comparative Examples 16 to 20)

On June 29, 258 seeds of soybeans (variety: Tachisuzunari) were sown (sowing interval: 20 seeds/m², 10a=1000 m² per plot) and grown in the open field. Planting soil was prepared by spraying the samples (including a commercial fertilizer) listed in Table 6 on soil (from Ibaraki Prefecture) and mixing them.

Harvesting was performed on October 15 of the same year. Plant height, grain weight, and thousand-kernel weight were measured for each plot, and an index for the grain weight was calculated, with a plant having no sample added (Comparative Example 16) being taken as 100 (Table 7).

TABLE 6
Soybean growth test (amount of sample added, unit: kg/a)

| | | | | | | lignin | | | |
|---|---|---|---|---|---|---|---|---|---|
| | | | | | | sulfonic | | | |
| | | | | | | acid | | | |
| | Sample | | | | | sample | sample | | |
| | used | N*¹ | P₂O₅*¹ | K₂O*¹ | MgO*² | 1 | 7 | AZUMIN | compost |
| Compar. | not added | 0.4 | 0.8 | 0.8 | 0 | 0 | 0 | 0 | 0 |
| Ex. 16 | (standard | | | | | | | | |
| | plot) | | | | | | | | |
| Compar. | standard | 0.4 | 0.8 | 0.8 | 200 | 0 | 0 | 0 | 0 |
| Ex. 17 | magnesia | | | | | | | | |
| | plot | | | | | | | | |
| Compar. | standard | 0.4 | 0.8 | 0.8 | 0 | 0 | 0 | 0 | 120 |
| Ex. 18 | compost | | | | | | | | |
| | plot | | | | | | | | |
| Ex. 10 | 40 kg | 0.4 | 0.8 | 0.8 | 0.2 | 4.0 | 0 | 0 | 0 |
| | sample-1 | | | | | | | | |
| | plot | | | | | | | | |
| Ex. 11 | 80 kg | 0.4 | 0.8 | 0.8 | 0.4 | 8.0 | 0 | 0 | 0 |
| | sample-1 | | | | | | | | |
| | plot | | | | | | | | |
| Ex. 12 | 40 kg | 0.4 | 0.8 | 0.8 | 0 | 0 | 4.0 | 0 | 0 |
| | sample-7 | | | | | | | | |
| | plot | | | | | | | | |
| Ex. 13 | 60 kg | 0.4 | 0.8 | 0.8 | 0 | 0 | 6.0 | 0 | 0 |
| | sample-7 | | | | | | | | |
| | plot | | | | | | | | |
| Compar. | 40 kg | 0.4 | 0.8 | 0.8 | 0.2 | 0 | 0 | 4.0 | 0 |
| Ex. 19 | sample-6 | | | | | | | | |
| | AZUMIN | | | | | | | | |
| | plot | | | | | | | | |
| Compar. | 60 kg | 0.4 | 0.8 | 0.8 | 0.3 | 0 | 0 | 6.0 | 0 |
| Ex. 20 | sample-6 | | | | | | | | |
| | AZUMIN | | | | | | | | |
| | plot | | | | | | | | |

### <Footnotes to Table 6>

*1 The amount of each of N, P₂O₅, and K₂O added represents the amount of each of the components added with respect to the total amount of a commercial fertilizer (manufactured by Sun and Hope corporation, including ammonium sulfate, calcium superphosphate, and potassium sulfate; N: ammonium sulfate 21%, P₂O₅: calcium superphosphate 16.5%, K₂O: potassium sulfate 50%) commonly added to each plot and a sample used in the plot.
*2 MgO represents the amount of MgO contained in each of the samples and was measured in the same manner as the MgO measurement method in Test Example 2.

TABLE 7
Soybean growth test (result)

| | | | grain | | thousand- |
|---|---|---|---|---|---|
| | | plant | weight | | kernel |
| | Sample | height | (kg/ | | weight |
| | used | (cm) *¹ | 10 a) *² | index | (g) *³ |
| Compar. | not added | 75.9 | 13.5 | 100 | 20.7 |
| Ex. 16 | (standard plot) | | | | |
| Compar. | standard | 82.7 | 13.9 | 103 | 21.2 |
| Ex. 17 | magnesia plot | | | | |
| Compar. | standard | 82.8 | 13.5 | 100 | 21.1 |
| Ex. 18 | compost plot | | | | |
| Ex. 10 | 40 kg sample-1 plot | 79.50 | 14.7 | 109 | 21.3 |
| Ex. 11 | 80 kg sample-1 plot | 79.60 | 14.3 | 106 | 20.5 |
| Ex. 12 | 40 kg sample-7 plot | 77.5 | 12.8 | 95 | 20.5 |
| Ex. 13 | 60 kg sample-7 plot | 78.2 | 12.4 | 92 | 20.4 |
| Compar. | 40 kg sample-6 | 79.6 | 13.9 | 103 | 21.3 |
| Ex. 19 | AZUMIN plot | | | | |
| Compar. | 60 kg sample-6 | 79.9 | 13.9 | 103 | 21.8 |
| Ex. 20 | AZUMIN plot | | | | |

### <Footnotes to Table 7>

*1 Plant height (cm) represents a height from the ground surface to a topmost end of each plant (N=4).
*2 Grain weight (g/m²=kg/10a) represents the weight of grains per plot (10a) (N=1).
*3 Thousand-kernel weight (unit: g) represents the average weight of 1000 grains (N=1).

In Examples, the grain weight of harvested soybean or plant height was larger than in Comparative Example 16 including no additives (standard plot). In particular, Example 10 also exhibited a larger value of thousand-kernel weight.

### Test Example 4: Calcium Carbonate Dispersion Test (B-Type Viscosity Test) (Example 14, Comparative Examples 21 to 24)

Effects on the dispersibility of calcium carbonate used as an extending agent for agrochemicals were evaluated.

To 172.44 g of calcium carbonate (water content of 30%), 37.56 g of water and each dispersant listed in Table 8 were added and stirred, whereby a slurry was prepared. The concentration of the slurry including water and calcium carbonate was 57%, and the amount of the dispersant added (solids addition rate) was 0.05% or 0.1% with respect to the total amount of the slurry. The stirring was performed using a homo disperser at 3000 rpm for 2 minutes. Using a B-type viscometer (manufactured by Toki Sangyo Co., Ltd), the B-type viscosity of the slurry after stirred was measured at 20° C. and 60 rpm by a No. 3 rotor or a No. 2 rotor without a guard (Table 8).

### <Table 8>

TABLE 8
Test result

| | | solids addition | B-type |
|---|---|---|---|
| | | rate | viscosity |
| | sample | (%) | (mPa ·s) |
| Compar. Ex. 21 | water only | 0 | 724 |
| | | 0 | 730 |
| Ex. 14 | sample 3 | 0.05 | 443 |
| | | 0.10 | 223 |
| Compar. Ex. 22 | sample 6 | 0.05 | 752 |
| | | 0.10 | 690 |
| Compar. Ex. 23 | sample 5 | 0.05 | 720 |
| | | 0.10 | 764 |
| Compar. Ex. 24 | sample 4 | 0.05 | 698 |
| | | 0.10 | 718 |

Example 14 using sample 3 had a lower viscosity than Comparative Examples 21 to 24 in which only water or samples 4 to 6 are used, and therefore the plant growth promoter according to the present invention exhibited good dispersibility, was kept in a planting medium, and was capable of enhancing dispersibility while including a fertilizer component and a pesticide component.

### Test Example 5: Fertilizer Efficiency Test Using Sample 1 (Examples 15 to 25, Comparative Examples 25 to 27)

### (1) Onion

On September 16, yellow onions (Kaizuka-wase) were sown in a seedbed. On November 18 of the same year, the seedlings were permanently planted in soil (red-yellow soil derived from beach sediments, each plot having an area of 13.1 m² (3.75×3.5 m) and two ridges). Permanent planting conditions were as follows: the ridge width was 75 cm, double-row planting was applied, an interval between plants was 12 cm, the planting density was 2222 plants/a, 2 kg/a of Kumiai compound fertilizer No. 11 (N, P₂O₅, K₂O), 0.4 kg/a of F-T-E (B: 9%, Mn: 19%), and humid acid PVA were tested as common fertilizers, and a fertilizer listed in Table 9 was added in each plot. On June 3 of the following year, harvesting was performed and yields were measured (Table 10).

TABLE 9
Test plot and design for fertilizer application (onion)

| | | treatment | note |
|---|---|---|---|
| Compar. | standard | — | |
| Ex. 25 | plot | | |
| Ex. 15 | 10 kg lignin | sample 1 10.0 kg/a | |
| | plot | | |
| Compar. | sulphate-of- | MgSO₄ 1.0 kg/a | The amount of MgO is |
| Ex. 26 | magnesia | | half the amount of |
| | plot | | MgO in lignin plot. |
| Compar. | Compost plot | compost 150 kg/a | |
| Ex. 27 | | | |

TABLE 10
Yield (onion)

| | | | | | | | | total weight | |
|---|---|---|---|---|---|---|---|---|---|
| | | fresh-onion yield | | | dry-matter yield | | | of dry-matters | |
| | | head | average | leaf | head | average | leaf | average | |
| | | part | index | part | part | index | part | yield | index |
| Compar. | standard | 540 | 100 | 64.0 | 43.6 | 100 | 4.4 | 48.8 | 100 |
| Ex. 25 | plot | 543 | | 64.0 | 44.6 | | 5.0 | | |
| Ex. 15 | 10 kg | 590 | 106 | 58.4 | 48.9 | 110 | 4.7 | 52.5 | 107 |
| | lignin | 566 | | 47.2 | 48.0 | | 3.3 | | |
| | plot | | | | | | | | |
| Compar. | sulphate- | 530 | 97 | 76.1 | 43.4 | 101 | 5.7 | 49.0 | 1.00 |
| Ex. 26 | of- | 534 | | 46.0 | 45.3 | | 3.5 | | |
| | magnesia | | | | | | | | |
| | plot | | | | | | | | |
| Compar. | compost | 540 | 102 | 49.6 | 46.4 | 104 | 3.9 | 49.9 | 1.02 |
| Ex. 27 | plot | 562 | | 50.5 | 45.4 | | 4.1 | | |

### <Footnotes to Table 10>

In Table 10, the results of examination of yield in a plot having an area of 1.8 m² and having fewer missing plants are illustrated.

### (2) Wheat

On November 14 (the day of sowing), soil was put into the lower layer of pots (up to 20 cm or lower from the openings of the pots), and then, on top of the soil, lignin samples (sample 1) in their respective amounts listed in Table 11 were put into the respective pots (up to 10 cm or lower from the openings of the pots), and then the soil was put again into the upper layer of the pots, whereby the pots with a middle-layer treatment plot were prepared. Separately, on November 4 (10 days before sowing) and November 14 (on the day of sowing), soil was put up to the middle layer of pots (10 cm or lower from the openings of the pots), and then the lignin samples in their respective amounts listed in Table 11 were put on top of the soil (up to the openings of the respective pots), whereby the pots with a surface-layer treatment plot were prepared. Note that, for each treatment plot, 2.0 g of N (ammonium sulfate), 1.0 g of P202 (calcium superphosphate or soluble phosphate), and 1.0 g of K₂O (potassium chloride) were used as common feed. For each treatment plot, wheat (wheat NORIN No. 50) was sown on November 14 at three places in each pot (four seeds per place). On December 15 of the same year, thinning was performed so as to leave three plants in each pot, and then, on June 15 of the following year, harvesting was performed after the plants fully grew in each pot (Table 11).

TABLE 11
Test plot and yield (wheat)

| | | | | | | number | harvest | | | yield index | |
|---|---|---|---|---|---|---|---|---|---|---|---|
| | Application | Application | | culm | ear | of | total | straw | grain | straw | grain |
| Ex. | time | part | | length | length | ears | weight | weight | weight | weight | weight |
| 16 | 10 | surface | 20 g lignin plot | 87.5 | 11.6 | 34.3 | 125.7 | 68.3 | 57.4 | 98.6 | 104.0 |
| 17 | days | layer | 40 g lignin plot | 87.0 | 11.7 | 33.3 | 129.4 | 71.2 | 58.2 | 104.0 | 105.4 |
| 18 | before | | 60 g lignin plot | 89.5 | 11.7 | 34.6 | 131.0 | 73.0 | 57.1 | 105.3 | 103.4 |
| 19 | sowing | | 100 g lignin plot | 90.2 | 11.6 | 35.3 | 129.5 | 70.1 | 59.4 | 101.2 | 107.6 |
| 20 | | middle | 20 g lignin plot | 85.3 | 11.7 | 33.3 | 126.0 | 69.0 | 57.0 | 99.6 | 103.3 |
| 21 | | layer | 40 g lignin plot | 86.4 | 11.6 | 34.6 | 125.7 | 69.4 | 56.3 | 100.1 | 102.2 |
| 22 | | | 60 g lignin plot | 88.0 | 11.8 | 33.6 | 127.8 | 70.2 | 57.6 | 101.3 | 104.3 |
| 23 | | | 100 g Lignin plot | 89.7 | 11.7 | 34.3 | 129.0 | 73.2 | 55.8 | 105.6 | 101.1 |
| 24 | on | surface | 30 g lignin plot | 87.2 | 11.6 | 34.6 | 128.6 | 70.6 | 58.0 | 101.9 | 105.1 |
| 25 | the | layer | 60 g lignin plot | 87.8 | 11.4 | 34.0 | 128.2 | 69.4 | 58.8 | 100.1 | 106.5 |
| | day | | | | | | | | | | |
| | of | | | | | | | | | | |
| | sowing | | | | | | | | | | |

### <Notes to Table 11>

In Table 11, the average of three ridges in one plot (air-dry matter amount per pot) are illustrated.

### Test Example 6: Fertilizer Efficiency Test Using Sample 2 (Examples 26 to 45, Comparative Examples 28 to 43)

### (1) Cucumber and Eggplant

On May 9, cucumber seedlings (Suyo cucumber, 4 true leaves, 8 cm in plant height) and eggplant seedlings (first-filial-generation Kono-wase-churyo eggplant, 5 true leaves, 18 cm in plant height) were transplanted (6 plants per 3.3 m² plot) into soil (diluvial sandy loam) and their growth was observed over time. Humic acid PVA was used as a common fertilizer, and another fertilizer in Table 12 was added for each plot. Plant growth examinations and yield measurements were conducted over time (Tables 13 and 14: N=3).

TABLE 12
Test plot and design for fertilizer
application (cucumber and eggplant)

| | |
|---|---|
| | urea compound |
| lignin | fertilizer 14-7-12 |

| | | magnesia | basal | top |
|---|---|---|---|---|
| | | (sample 2) | dressing | dressing |
| Compar. | no- | — | 300 | 100 |
| Ex. 28, 29 | treatment | | | |
| | plot | | | |
| Ex. 26, 28 | normal- | 100 g/3.3 m² | 300 | 100 |
| | amount-of- | | | |
| | lignin | | | |
| | plot | | | |
| Ex. 27, 29 | increased- | 150 g/3.3 m² | 300 | 100 |
| | amount-of- | | | |
| | lignin | | | |
| | plot | | | |

TABLE 13
Growth amount and yield of cucumber

| | | | | | | | | | total | |
|---|---|---|---|---|---|---|---|---|---|---|
| | | | | | | | | | yield | |
| | | | | | | | | | from | |
| | | | | | | | | | 6/18 to | |
| | | | 7/18 | | 7/28 | | 8/7 | | 8/7 | |
| Compar. | no- | growth | 130.2 | (12) | 141.2 | (12) | 160.6 | (12) | | |
| Ex. 28 | treatment | amount | | | | | | | | |
| | plot | yield | 100 | (1) | 563 | (4) | 241 | (2) | 1464 | (13) |
| Ex. 26 | normal- | growth | 162.0 | (15) | 188.9 | (17) | 204.2 | (17) | | |
| | amount-of- | amount | | | | | | | | |
| | lignin | yield | 578 | (3) | 1165 | (5) | 721 | (4) | 4232 | (24) |
| | plot | | | | | | | | | |
| Ex. 27 | increased- | growth | 149.6 | (13) | 164.4 | (16) | 184.0 | (17) | | |
| | amount-of- | amount | | | | | | | | |
| | lignin | yield | 845 | (4) | 2361 | (6) | 661 | (3) | 4675 | (22) |

plot

TABLE 14
Growth amount and yield of eggplant

| | | | | | | | | | | | total |
|---|---|---|---|---|---|---|---|---|---|---|---|
| | | | | | | | | | | | yield |
| | | | | | | | | | | | from |
| | | | | | | | | | | | 6/18 to |
| | | | 5/28 | 6/8 | 6/18 | 6/28 | 7/8 | 7/18 | 7/28 | 8/7 | 8/7 |
| Compar. | standard | growth amount | 20.0 | 23.1 | 33.2 | 37.0 | 47.0 | 50.2 | 52.1 | 53.3 | |
| Ex. 29 | plot | | (2) | (2) | (3) | (3) | (3) | (4) | (4) | (4) | |
| | | yield | | | 26 | 41 | 66 | 40 | 63 | 24 | 260 |
| | | | | | (1) | (2) | (3) | (1) | (4) | (1) | (12) |
| Ex. 28 | normal-amount- | growth amount | 21.7 | 28.9 | 38.8 | 41.0 | 55.9 | 57.8 | 62.1 | 65.0 | |
| | of-lignin plot | | (3) | (4) | (4) | (4) | (6) | (7) | (7) | (7) | |
| | | yield | | | 82 | 212 | 396 | 273 | 442 | 62 | 1468 |
| | | | | | (3) | (4) | (6) | (5) | (7) | (3) | (28) |
| Ex. 29 | increased-amount- | growth amount | 22.8 | 29.2 | 37.9 | 40.0 | 56.0 | 58.6 | 63.1 | 78.0 | |
| | of-lignin | | (3) | (4) | (4) | (4) | (6) | (7) | (7) | (7) | |
| | plot | yield | | | 28 | 109 | 117 | 230 | 395 | 68 | 947 |
| | | | | | (2) | (3) | (3) | (4) | (5) | (3) | (20) |

### <Footnotes Given to Tables 13 and 14>

A plant growth amount represents a growth amount (cm) of an average of one plant in each plot.

A number in parentheses in the plant growth amount represents the number of leaves of cucumber or the number of branches of eggplant.

A yield represents the total amount (g) of three plants in each plot.

A number in parentheses in the yield represents the number of plants.

### (2) Melon

Melons (Earl's-type, NANEN No. 2) were divided into three plots (Table 15) and grown in each plot having an area of 1 m² and one ridges in a plastic greenhouse. On June 8, sowing was performed in soil (diluvial clay loam). On June 15, temporary planting was performed. On July 2, permanent planting (four true leaves) was performed. Then, pinching (on July 18), cross-fertilization (on July 21 to 26), fruit-thinning (on July 29), suspension (on July 30), and bagging (on August 7) were sequentially performed, and harvesting was performed on September 4. Fertilizer application was performed using fertilizers listed in Table 15 and a common fertilizer (humic acid, PVA-based) for each plot in such a manner that the first application (basal dressing) was performed on July 2, the second application (first top-dressing) was performed immediately after fruit-thinning, and the third application (second top-dressing) was performed at the beginning of appearing a net pattern on a surface. Irrigation was performed twice before cross-fertilization and three times after cross-fertilization. Dithane and Karathane were sprayed seven times as a fungicide and a disinfectant. Temperature and humidity were controlled as follows: at a seedling raising stage, 30° C. in the daytime and 22° C. in the nighttime; at a vegetative stage, 32° C. in the daytime and 25° C. in the nighttime and a nighttime humidity of 75%; at a fruiting stage, 32° C. in the daytime and 24° C. in the nighttime and a nighttime humidity of 948; and, at a harvesting stage, windows were opened to reduce humidity. Yields were measured and resulting fruits were evaluated (Tables 16 and 17).

TABLE 15
Test plot and design for fertilizer application (melon) (unit: g)

| | | lignin | | | | | |
|---|---|---|---|---|---|---|---|
| | | (sample | | | | | |
| | | 2) | oil | calcium | potassium | slaked | |
| | | (MgO5%) | cake | superphosphate | sulfate | lime | compost |
| Compar. | no- | — | 200 | 80 | 24 | 70 | 1120 |
| Ex. 30 | treatment | | 80-40- | | 12-6- | | 560- |
| | plot | | 40-40 | | 6 | | 560 |

TABLE 16
Yield (melon)

| | | total | yield per |
|---|---|---|---|
| | | yield | piece |
| Comparative | no-treatment plot | 3050 g | 1017 g |
| Example 30 | | | |
| Example 30 | 0.05% lignin plot | 3301 g | 1100 g |
| Example 31 | 0.1% lignin plot | 3277 g | 1093 g |

TABLE 17
Fruit examination (melon, test values of representative
fruit selected as close to the average)

| | | | | | | fruit | | | |
|---|---|---|---|---|---|---|---|---|---|
| | | fruit | sugar content | | | size (cm) | | | net |
| | | weight | fruit | fruit | fruit | fruit | fruit | eating | form |
| | | (cm) | apex | bottom | core | length | width | quality | (cm) |
| Compar. | no- | 980 | 12 | 12.0 | 12.5 | 11.7 | 12.4 | fair | 4.5 |
| Ex. 30 | treatment | | | | | | | | |
| | plot | | | | | | | | |
| Ex. 30 | 0.05% | 1100 | 12 | 12.2 | 12.5 | 12 | 12.5 | good | 4.5 |
| | lignin | | | | | | | | |
| | plot | | | | | | | | |
| Ex. 31 | 0.1% | 1100 | 12 | 12.5 | 13.2 | 12 | 13 | good | 5 |
| | lignin | | | | | | | | |
| | piot | | | | | | | | |

### (3) Corn

Into a 1/2000a Wagner pots (arranged in three lines), soil (any of the followings: sediment-filled alluvial upland topsoil from the Kofu Basin and brown volcanic ash subsoil from Yatsugatake) was put. On June 28, seeds of corn for feedstuff was sown and fertilized (Table 18). Plant growth examinations were performed over time, and harvesting was performed on August 12.

TABLE 18
Test plot and design for fertilizer application (corn) (unit: g)

| | | | | | | | | | | | lignin | |
|---|---|---|---|---|---|---|---|---|---|---|---|---|
| | | | | | | | | | | | magnesia | |
| | | | | | | | | ammonium | calcium | potassium | (sample | |
| | | | N | P₂O₅ | K₂O | CaCO₃ | MgO | sulfate | superphosphate | sulfate | 2) | compost |
| Compar. | alluvial | standard | 1.0 | 1.0 | 1.0 | 2.5 | — | 5 | 5 | 2 | — | — |
| Ex. 31 | soil | plot | | | | | | | | | | |
| Ex. 32 | | lignin | | | | | 0.3 | | | | 6.0 | |
| | | plot | | | | | | | | | | |
| Ex. 33 | | double- | | | | | 0.6 | | | | 12.0 | |
| | | amount- | | | | | | | | | | |
| | | of- | | | | | | | | | | |
| | | lignin | | | | | | | | | | |
| | | plot | | | | | | | | | | |
| Compar. | | compost | | | | | — | 2 | 4 | 1 | — | 10.0 |
| Ex. 32 | | plot | | | | | | | | | | |
| Compar. | volcanic | standard | 1.5 | 2.0 | 1.5 | 7.5 | — | 7 | 10 | 3 | — | — |
| Ex. 33 | ash | plot | | | | | | | | | | |
| Ex. 34 | soil | lignin | | | | | 0.3 | | | | 6.0 | |
| | | plot | | | | | | | | | | |
| Ex. 35 | | double- | | | | | 0.6 | | | | 12.0 | |
| | | amount- | | | | | | | | | | |
| | | of- | | | | | | | | | | |
| | | lignin | | | | | | | | | | |
| | | plot | | | | | | | | | | |
| Compar. | | compost | | | | | — | 5 | 9 | 2 | | 10.0 |
| Ex. 34 | | plot | | | | | | | | | | |

### <Footnotes to Table 18>

Three elements, CaCO₃, lignin (sample 2), and compost were mixed into all layers from 0 to 10 cm.

The fertilizers applied were as follows: ammonium sulfate 21%, calcium superphosphate 19.5%, potassium sulfate 50%; compost components, N 0.59%, P₂O₅ 0.23%, and K₂O 0.66% deducted; lignin magnesia MgO 5.0%.

TABLE 19
Harvest analysis result (corn) (harvesting stage, dry- matter %)

| | | | N | | | P₂O₅ | | | K₂O | | |
|---|---|---|---|---|---|---|---|---|---|---|---|
| | | | | absorption | | | absorption | | | absorption | |
| | | | content | amount | index | content | amount | index | content | amount | index |
| Comparative | alluvial | standard | 1.45 | 2.52 | 100 | 0.98 | 1.70 | 100 | 4.34 | 7.54 | 100 |
| Example 31 | soil | plot | | | | | | | | | |
| Example 32 | | Lignin | 1.45 | 2.84 | 113 | 1.07 | 1.98 | 117 | 5.44 | 10.66 | 141 |
| | | plot | | | | | | | | | |
| Example 33 | | double- | 1.38 | 2.70 | 107 | 1.10 | 2.17 | 128 | 4.55 | 9.00 | 119 |
| | | amount- | | | | | | | | | |
| | | of- | | | | | | | | | |
| | | Lignin | | | | | | | | | |
| | | plot | | | | | | | | | |
| Comparative | | compost | 1.19 | 2.15 | 85 | 1.26 | 2.28 | 134 | 5.15 | 9.31 | 123 |
| Example 32 | | plot | | | | | | | | | |
| Comparative | volcanic | standard | 1.49 | 2.18 | 100 | 0.59 | 1.27 | 100 | 6.09 | 13.09 | 100 |
| Example 33 | ash | plot | | | | | | | | | |
| Example 34 | soil | lignin | 1.39 | 3.42 | 157 | 0.65 | 1.60 | 126 | 6.66 | 16.38 | 125 |
| | | plot | | | | | | | | | |
| Example 35 | | double- | 1.16 | 2.27 | 104 | 0.71 | 1.40 | 110 | 4.97 | 9.73 | 74 |
| | | amount- | | | | | | | | | |
| | | of- | | | | | | | | | |
| | | lignin | | | | | | | | | |
| | | plot | | | | | | | | | |
| Comparative | | compost | 0.89 | 1.75 | 80 | 0.64 | 1.11 | 87 | 6.25 | 10.87 | 83 |
| Example 34 | | plot | | | | | | | | | |

TABLE 20
Results of harvest analysis and yield examination (corn) (harvesting stage, dry -matter %)

| | | | | | | | | | yield | | | |
|---|---|---|---|---|---|---|---|---|---|---|---|---|
| | | | | | | | | | corn for | | | |
| | | | Cao | | | MgO | | | feedstuff | | | |
| | | | | absorption | | | absorption | | total | | air-dry | |
| | | | content | amount | index | content | amount | index | weight | index | weight | index |
| Comparative Example 31 | alluvial | standard plot | 0.71 | 1.23 | 100 | 0.32 | 0.56 | 100 | 907 | 100 | 193.5 | 100 |
| Example 32 | soil | lignin plot | 0.76 | 1.49 | 121 | 0.47 | 0.92 | 164 | 1013 | 111 | 213.0 | 110 |
| Example 33 | | double-amount- | 0.72 | 1.42 | 116 | 0.43 | 0.85 | 152 | 1163 | 128 | 214.0 | 111 |
| | | of-lignin plot | | | | | | | | | | |
| Comparative Example 32 | | compost plot | 0.72 | 1.30 | 106 | 0.31 | 0.56 | 100 | | | | |
| Comparative Example 33 | volcanic | standard plot | 0.85 | 1.83 | 100 | 0.44 | 0.95 | 100 | | | | |
| Example 34 | ash | lignin plot | 0.78 | 1.92 | 105 | 0.35 | 0.86 | 91 | | | | |
| Example 35 | soil | double-amount- | 0.72 | 1.41 | 77 | 0.74 | 1.45 | 153 | | | | |
| | | of-lignin plot | | | | | | | | | | |
| Comparative Example 34 | | compost plot | 0.61 | 1.06 | 58 | 0.46 | 0.80 | 84 | | | | |

### (4) Turnip

Into a 1/2000a Wagner pot, soil (any of the followings: sediment-filled alluvial upland topsoil from the Kofu Basin and brown volcanic ash subsoil from Yatsugatake) to which lignin (sample 2) was added was put. Small turnips (Someya Kanamachi) were sown on April 30 and fertilizer application was performed (Table 21). On May 20 and 30, disinfection and the like were performed. On June 7, weeding was performed. Plant growth examinations were performed over time during cultivation (Table 22). On June 11, harvesting was performed, and yields were examined (Table 23).

TABLE 21
Test plot and design for fertilizer application (turnip) (unit: g)

| | | | | | | | | ammonium | calcium | potassium | sulphate | lignin |
|---|---|---|---|---|---|---|---|---|---|---|---|---|
| | | | N | P₂O₅ | K₂O | Ca | Mgo | sulfate | superphosphate | sulfate | of magnesia | magnesia |
| Compar. | alluvial | standard plot | 2.0 | 2.0 | 2.0 | 5.0 | — | 10 | 11 | 4 | — | — |
| Ex. 35 | soil | | | | | | | | | | | |
| Ex. 36 | | lignin plot | | | | | 0.3 | | | | — | 6.0 |
| Ex. 37 | | double-amount- | | | | | 0.6 | | | | — | 12.0 |
| | | of-lignin plot | | | | | | | | | | |
| Compar. | | sulphate-of- | | | | | 0.3 | | | | 1.8 | — |
| Ex. 36 | | magnesia plot | | | | | | | | | | |
| Compar. | volcanic | standard plot | 2.5 | 3.8 | 2.5 | 15.0 | — | 12 | 20 | 5 | — | — |
| Ex. 37 | ash | | | | | | | | | | | |
| Ex. 38 | soil | lignin plot | | | | | 0.3 | | | | — | 6.0 |
| Ex. 39 | | double-amount- | | | | | 0.6 | | | | — | 12.0 |
| | | of-lignin plot | | | | | | | | | | |
| Compar. | | sulphate-of- | | | | | 0.3 | | | | 1.8 | — |
| Ex. 38 | | magnesia plot | | | | | | | | | | |

TABLE 22
Plant growth examination (turnip) (average of three ridges)

| | | | May 29 | | | | June 11 | | | | | | | |
|---|---|---|---|---|---|---|---|---|---|---|---|---|---|---|
| | | | leaf | | leaf | | leaf | | leaf | | number | | root | |
| | | | length | index | width | index | length | index | width | index | of leaves | index | width | length |
| Compar. | alluvial | standard | 12.6 | 100 | 5.7 | 100 | 19.9 | 100 | 7.7 | 100 | 8.7 | 100 | 1.5 | 1.5 |
| Ex. 35 | soil | plot | | | | | | | | | | | | |
| Ex. 36 | | lignin plot | 12.9 | 102 | 5.1 | 89 | 19.8 | 99 | 9.2 | 119 | 9.3 | 107 | 1.6 | 1.9 |
| Ex. 37 | | double- | 12.4 | 98 | 5.2 | 91 | 22.3 | 112 | 8.0 | 104 | 9.7 | 111 | 1.5 | 1.8 |
| | | amount-of- | | | | | | | | | | | | |
| | | lignin plot | | | | | | | | | | | | |
| Compar. | | sulphate- | 13.9 | 110 | 6.0 | 105 | 22.8 | 115 | 8.6 | 112 | 8.3 | 95 | 1.9 | 1.9 |
| Ex. 36 | | of-magnesia | | | | | | | | | | | | |
| | | plot | | | | | | | | | | | | |
| Compar. | volcanic | standard | 18.2 | 100 | 7.8 | 100 | 23.9 | 100 | 9.8 | 100 | 9.1 | 100 | 2.9 | 2.4 |
| Ex. 37 | ash | plot | | | | | | | | | | | | |
| Ex. 38 | soil | lignin plot | 19.6 | 108 | 8.6 | 110 | 27.5 | 115 | 11.1 | 113 | 9.0 | 93 | 2.9 | 3.0 |
| Ex. 39 | | double- | 22.3 | 122 | 8.1 | 104 | 31.8 | 133 | 11.1 | 113 | 9.7 | 100 | 2.9 | 3.3 |
| | | amount-of- | | | | | | | | | | | | |
| | | lignin plot | | | | | | | | | | | | |
| Compar. | | sulphate- | 17.0 | 93 | 7.1 | 91 | 23.7 | 99 | 9.7 | 99 | 10.6 | 109 | 2.5 | 2.7 |
| Ex. 38 | | of-magnesia | | | | | | | | | | | | |
| | | plot | | | | | | | | | | | | |

TABLE 23
Yield examination (turnip)

| | | | total | | leaf | | | | |
|---|---|---|---|---|---|---|---|---|---|
| | | | weight | | weight | | number of | | |
| | | | (g) | index | (g) | index | turnips | index | quality |
| Compar. | alluvial | standard | 20.1 | 100 | 13.8 | 100 | 6.2 | 100 | low |
| Ex. 35 | soil | plot | | | | | | | |
| Ex. 36 | | lignin | 24.8 | 123 | 17.9 | 130 | 6.8 | 110 | average |
| | | plot | | | | | | | |
| Ex. 37 | | double- | 22.9 | 114 | 15.7 | 114 | 7.2 | 116 | average |
| | | amount-of- | | | | | | | |
| | | lignin | | | | | | | |
| | | plot | | | | | | | |
| Compar. | | sulphate- | 26.0 | 129 | 19.0 | 138 | 7.0 | 113 | average |
| Ex. 36 | | of- | | | | | | | |
| | | magnesia | | | | | | | |
| | | plot | | | | | | | |
| Compar. | volcanic | standard | 37.1 | 100 | 23.6 | 100 | 13.5 | 100 | low |
| Ex. 37 | ash | plot | | | | | | | |
| Ex. 38 | soil | lignin | 40.9 | 110 | 26.9 | 114 | 14.0 | 104 | average |
| | | plot | | | | | | | |
| Ex. 39 | | double- | 50.8 | 137 | 33.7 | 143 | 17.2 | 127 | high |
| | | amount-of- | | | | | | | |
| | | lignin | | | | | | | |
| | | plot | | | | | | | |
| Compar. | | sulphate- | 35.2 | 95 | 23.8 | 101 | 11.4 | 84 | low |
| Ex. 38 | | of- | | | | | | | |
| | | magnesia | | | | | | | |
| | | plot | | | | | | | |

### (5) Upland Rice

Rice plants (upland rice NORIN No. 1 (glutinous rice)) were sown in two rows each having a planting density of 30 seeds per row) in soil (diluvial upland soil) and fertilized on May 13 (Table 24). On November 4 of the same year, harvesting was performed and plant growth examinations were performed (Table 25).

TABLE 24
Test plot and design for fertilizer application
(upland rice) (unit: g/m²)

| | | Compound | |
|---|---|---|---|
| | | fertilizer | lignin magnesia |
| Comparative | standard | 66 | — |
| Example 39 | plot | | |
| Example 40 | lignin | | 40 (MgO: 2.0 kg/10 a) |
| | 40 plot | | |
| Example 41 | lignin | | 60 (MgO: 3.0 kg/10 a) |
| | 60 plot | | |

### <Footnotes to Table 24>

Compound fertilizer: N 1.0 kg/10a, P₂O₅ 1.0 kg/10a, K₂O 0.8 kg/10a (Kumiai Rinshoankari: N 15.0%, P 15.0%, K 12.0%) Lignin magnesia MgO 5.0%

TABLE 25
Growth amount and yield of upland rice

| | | Growth examination | | | | | | | | |
|---|---|---|---|---|---|---|---|---|---|---|
| | | at harvesting stage | | | | | | | | |
| | | (per plot, average | | | | yield examination | | | | |
| | | of three ridges) | | | | (average per plot) | | | | |
| | | culm | | number | | total | straw | | paddy | |
| | | length | index | of ears | index | weight | weight | index | weight | index |
| Comparative | standard | 91.7 | 100 | 155.3 | 100 | 698 | 331 | 100 | 314 | 100 |
| Example 39 | plot | | | | | | | | | |
| Example 40 | Lignin | 94.7 | 103 | 161.7 | 104 | 715 | 339 | 102 | 324 | 103 |
| | 40 plot | | | | | | | | | |
| Example 41 | lignin | 91.7 | 100 | 159.0 | 102 | 672 | 328 | 99 | 294 | 94 |
| | 60 plot | | | | | | | | | |

### (6) Summer-Planting Carrot

Soil was tilled to 15 cm depth, and a common fertilizer and a fertilizer listed in Table 26 were applied to a fertilizer furrow. Ridges having a ridge width of 60 cm were built (13.1 m² (3.75 m×3.5 m) per plot). On June 11, carrots (Kuroda-gosun carrot) were sown (two-row seeding). Thinning was performed so as to make a space between plants of 15 cm and approximately 2,220 plants/a. When the soil was dried until soil moisture tension at a depth of 10 cm in a row exceeded pF 2.5, spray irrigation was performed with 20 to 30 mm of water each time, 180 mm of water in total. On September 16, harvesting was performed, and yields and the component content and nutrient absorption amount of a harvest were measured (Tables 27 and 28).

TABLE 26
Test plot and design for fertilizer
application (summer-planting carrot)

| | | treatment | |
|---|---|---|---|
| | | (rows formed) | note |
| Comparative | standard plot | — | |
| Example 40 | | | |
| Example 42 | 5 kg lignin | lignin | equal |
| | (sample 2) | magnesia | in Mgo |
| | plot | 5 kg/a | amount |
| Comparative | sulphate-of- | MgSO₄ | |
| Example 41 | magnesia plot | 1 kg/3.3 m² | |

TABLE 27
Yield of summer-planting carrot (average of two ridges)

| | | fresh root- | | fresh leaf- | | total of | | dry-matter yield kg/a | | | |
|---|---|---|---|---|---|---|---|---|---|---|---|
| | | part yield | | part yield | | fresh parts | | root | leaf | | |
| | | kg/a | index | kg/a | index | kg/a | index | part | part | total | index |
| Comparative | standard | 218 | 100 | 191 | 100 | 409 | 100 | 23.9 | 27.0 | 50.9 | 100 |
| Example 40 | plot | | | | | | | | | | |
| Example 42 | 5 kg | 238 | 109 | 218 | 112 | 456 | 112 | 25.1 | 29.8 | 54.9 | 108 |
| | lignin | | | | | | | | | | |
| | plot | | | | | | | | | | |
| Comparative | sulphate- | 208 | 95 | 196 | 101 | 404 | 99 | 21.6 | 26.4 | 48.0 | 94 |
| Example 41 | of- | | | | | | | | | | |
| | magnesia | | | | | | | | | | |
| | plot | | | | | | | | | | |

TABLE 28
Component content and nutrient absorption amount of summer-planting carrot

| | | Component content (with | | | | | | nutrient absorption | | |
|---|---|---|---|---|---|---|---|---|---|---|
| | | respect to 105° C. dry matter %) | | | | | | amount(kg/a) | | |
| | | | | | | | | total of root | | |
| | | root part | | | leaf part | | | and leaf parts | | |
| | | N | P₂O₅ | K₂O | N | P₂O₅ | K₂O | N | P₂O₅ | K₂O |
| Comparative | standard | 1.7 | 1.3 | 4.4 | 1.9 | 0.77 | 1.5 | 0.90 | 0.51 | 2.5 |
| Example 40 | plot | | | | | | | | | |
| Example 42 | 5 kg | 1.7 | 1.4 | 4.7 | 1.8 | 0.86 | 1.7 | 0.95 | 0.60 | 2.9 |
| | lignin | | | | | | | | | |
| | plot | | | | | | | | | |
| Comparative | sulphate- | 1.7 | 1.4 | 4.6 | 1.9 | 0.86 | 1.7 | 0.86 | 0.51 | 2.5 |
| Example 41 | of- | | | | | | | | | |
| | magnesia | | | | | | | | | |
| | plot | | | | | | | | | |

### (7) Autumn-Planting Carrot

A common fertilizer and fertilizers listed in Table 29 were applied to soil (humus-poor fine-grained soil derived from unconsolidated diluvial sediments) (on August 2). Ridges having a ridge width of 60 cm were built (each plot having an area of 9 m² (3 m×3 m) and three ridges per plot). On September 1, carrots (Kuroda-gosun carrot) were sown (two-row seeding). Thinning was performed so as to make a space between plants of 15 cm and approximately 2,220 plants/a. When the soil was dried until soil moisture tension at a depth of 10 cm in a row exceeded pF 2.5, spray irrigation was performed with 10 to 20 mm of water each time, 220 mm of water in total. On January 6 of the following year, harvesting was performed, and plant growth examinations were conducted and nutrient absorption amount was measured (Table 30).

TABLE 29
Test plot and design for fertilizer application (autumn-planting carrot)

| | | | | basal | | | top | |
|---|---|---|---|---|---|---|---|---|
| | | treatment | | dressing kg/a | | | dressing kg/a | |
| | | N | sample 2 | N | P₂O₅ | K₂O | N | K₂O |
| Compar. | basal | single | not applied | 2 | 2 | 1 | — | 1 |
| Ex. 42 | dressing | application | | | | | | |
| | control | of fertilizer | | | | | | |
| Compar. | split- | split | not applied | 1 | | | 1 | |
| Ex. 43 | application | application | | | | | | |
| | control | of fertilizer | | | | | | |
| Ex. 43 | split- | | 5 kg/a sprayed | | | | | |
| | application | | over entire | | | | | |
| | L5 | | surface | | | | | |
| Ex. 44 | split- | | 15 kg/a sprayed | | | | | |
| | application | | over entire | | | | | |
| | L15 | | surface | | | | | |
| Ex. 45 | split- | | 15 kg/a of sample | | | | | |
| | application | | 2 was mixed | | | | | |
| | of mixture | | with calcium | | | | | |
| | | | superphosphate | | | | | |
| | | | and applied | | | | | |
| | | | into furrow | | | | | |

TABLE 30
Leaf color and nutrient absorption amount of autumn-planting carrot

| | | | N | | P₂O₅ | | K₂O | | Cao | | MgO | |
|---|---|---|---|---|---|---|---|---|---|---|---|---|
| | | | total | | total | | total | | total | | total | |
| | | | of root | | of root | | of root | | of root | | of root | |
| | | leaf | and leaf | | and leaf | | and leaf | | and leaf | | and leaf | |
| | | color | parts | index | parts | index | parts | index | parts | index | parts | index |
| Compar. | basal | −− | 0.58 | — | 0.21 | — | 1.4 | — | 0.37 | — | 0.090 | — |
| Ex. 42 | dressing | | | | | | | | | | | |
| | control | | | | | | | | | | | |
| Compar. | split- | ++ | 0.76 | 100 | 0.25 | 100 | 1.7 | 100 | 0.38 | 100 | 0.096 | 100 |
| Ex. 4 | application | | | | | | | | | | | |
| | control | | | | | | | | | | | |
| Ex. 43 | split- | ++ | 0.97 | 129 | 0.30 | 120 | 1.9 | 112 | 0.39 | 103 | 0.120 | 125 |
| | application | | | | | | | | | | | |
| | L5 | | | | | | | | | | | |
| Ex. 44 | split- | ++ | 0.88 | 116 | 0.29 | 116 | 1.9 | 112 | 0.39 | 103 | 0.120 | 125 |
| | application | | | | | | | | | | | |
| | L15 | | | | | | | | | | | |
| Ex. 45 | split- | ++ | 1.00 | 132 | 0.32 | 128 | 2.0 | 118 | 0.43 | 113 | 0.140 | 146 |
| | application | | | | | | | | | | | |
| | of mixture | | | | | | | | | | | |

### Test Example 7: Fertilizer Efficiency Test Using Ca Lignin Sulfonate (Examples 46 to 49, Comparative Examples 44 to 47)

### (1) Onion

On September 6, yellow onions (Senshu yellow onion) were sown in a seedling box. On November 10, the seedlings were permanently planted in soil (sediment-filled alluvial soil from the Kofu Basin, loamy soil). Permanent planting conditions were a ridge width of 100 cm, four-row seeding, a space between rows of 18 cm, and a space between plants of 12 cm. Fertilizer application was performed using fertilizers listed in Tables 31 and 32 (in addition, nitrofumic acid PVA and the like) in such a manner that basal dressing was applied on November 6 and top dressing was applied on February 23, March 28, and April 16 of the following year. On July 9, harvesting was performed, and yields were measured (Table 33). The number of rotten onions at the time of harvest on July 9 was examined (Table 34).

TABLE 31
Test plot and treatment method (onion)

| | | Application | |
|---|---|---|---|
| | | amount | treatment method |
| Comparative | standard | — | |
| Example 44 | plot | | |
| Comparative | compost | compost | after tillage, sprayed |
| Example 45 | plot | 1500 | over entire surface and |
| | | | mixed with approximately |
| | | | 10 cm of topsoil |
| Example 46 | lignin | lignin Ca | after tillage, sprayed |
| | plot | 50 | over entire surface and |
| | | | mixed with approximately 5 |
| | | | cm of topsoil |

TABLE 32
design for fertilizer application (onion)

| | | three-element | | | | actual fertilizer | | | |
|---|---|---|---|---|---|---|---|---|---|
| | | amount | | | | application amount | | | |
| | | | P₂O₅ | | | | calcium | soluble | potassium |
| | | N | S.P | F.P | K₂O | urea | superphosphate | phosphate | sulfate |
| Comparative | standard | S-4- | 10 | 10 | 16 | 17.4-8.7- | 60.6 | 52.6 | 32.0 |
| Example 44 | plot | 6-6 | | | | 13.0-13.0 | | | |

TABLE 33
Yield (onion)

| | | | 200 g or more | | 200 to 100 g | | 100 g or less | | total | |
|---|---|---|---|---|---|---|---|---|---|---|
| | | | number | | number | | number | | number | |
| | | | of onions | weight | of onions | weight | of onions | weight | of onions | weight |
| Comparative | average | standard | 4000 | 1021 | 13300 | 2018 | 5500 | 379 | 22800 | 3418 |
| Example 44 | yield | plot | | | | | | | | |
| Comparative | (kg/10 a) | compost | 5200 | 1315 | 11500 | 1702 | 5900 | 405 | 22600 | 3422 |
| Example 45 | by head | plot | | | | | | | | |
| Example 46 | weight | lignin | 5500 | 1344 | 13900 | 2128 | 3300 | 245 | 33600 | 3717 |
| | | plot | | | | | | | | |
| Comparative | yield | standard | 100 | 100 | 100 | 100 | 100 | 100 | 100 | 100 |
| Example 44 | index by | plot | | | | | | | | |
| Comparative | head | compost | 130 | 129 | 87 | 84 | 107 | 107 | 99 | 100 |
| Example 45 | weight | plot | | | | | | | | |
| Example 46 | | lignin | 137 | 132 | 105 | 105 | 60 | 65 | 147 | 109 |
| | | plot | | | | | | | | |
| | | | weight | index | weight | index | weight | index | weight | index |
| Comparative | average | standard | 255 | 100 | 152 | 100 | 73 | 100 | 151 | 100 |
| Example 44 | per | plot | | | | | | | | |
| Comparative | onion | compost | 212 | 83 | 148 | 97 | 69 | 95 | 145 | 96 |
| Example 45 | | plot | | | | | | | | |
| Example 46 | | lignin | 225 | 88 | 157 | 103 | 74 | 101 | 168 | 111 |
| | | plot | | | | | | | | |

TABLE 34
Number of rotten onions (per 9.9 m²)

| | | number of |
|---|---|---|
| | | rotten onions |
| Comparative Example 44 | standard plot | 11 |
| Example 46 | lignin plot | 5 |

Weather conditions during plant growth were not good, that is, dry and low in temperature, and were heavily rainy and short of sunshines during harvesting.

It was observed that, in the lignin treatment plot, leaf color is slightly paler than the standard plot, but there was no significant difference in plant height and the number of leaves between the lignin treatment plot and the standard plot.

When onions were sampled to investigate the growing state of the onion heads on March 28, the lignin plot exhibited slightly superior results. A relatively clear difference was observed in the number of onions having a weight of 200 g or more between the lignin plot and the standard plot, and thus the lignin plot exhibited clearly more excellent results than the standard plot.

Furthermore, the lignin plot was higher in yield than the standard plot. Furthermore, the lignin plot had fewer rotten onions than the standard plot.

It was found that the use of lignin for growing onions brought about an increase in crop quality, for example, a reduction in the number of rotten onions and an increase in the number of heavy-weight onions.

### (2) Paddy Rice

On June 26, rice (Pi5) seedlings were planted in a rice paddy (paddy soil: granitic sandy loam, 10 m² (3 m×3.35 m) per plot), with three seedlings per plant (planting density: 32 plants per 1 m² (25 cm×12.5 cm)). The fertilizers listed in Table 34 were applied at various stages. Heading occurred on September 2, and then chemicals such as diazinon, PCP, and Fumiron, were sprayed. On October 31, harvesting was performed, and plant growth examinations were performed and the phosphoric acid content and the potassium content were measured (Tables 36 and 37).

TABLE 35
Test plot and design for fertilizer application (paddy rice) (unit: kg/10 a)

| | | N (ammonium sulfate) | | | P₂O₅ (multi- | K₂O (potassium sulfate) | | | |
|---|---|---|---|---|---|---|---|---|---|
| | | | application of | application of | phosphate) | | application of | | |
| | | basal | fertilizer for | fertilizer at | basal | basal | fertilizer at | | lignin |
| | | dressing | tillering | heading stage | dressing | dressing | heading stage | compost | Ca |
| Compar. | standard plot | 10 | 5 | 3 | 10 | 10 | 3 | 0 | 0 |
| Ex. 46 | | | | | | | | | |
| Compar. | compost plot | 10 | 5 | 3 | 10 | 10 | 3 | 4500 | 0 |
| Ex. 47 | | | | | | | | | |
| Ex. 47 | lignin plot | 0 | 0 | 0 | 10 | 10 | 0 | 0 | 1300 |
| Ex. 48 | lignin and | 10 | 0 | 3 | 10 | 10 | 3 | 0 | 1300 |
| | less-amount- | | | | | | | | |
| | of-fertilizer | | | | | | | | |
| | plot | | | | | | | | |
| Ex. 49 | lignin and | 10 | 5 | 3 | 10 | 10 | 3 | 0 | 1300 |
| | normal- | | | | | | | | |
| | amount-of- | | | | | | | | |
| | fertilizer | | | | | | | | |
| | plot | | | | | | | | |

TABLE 36
Growth amount and yield of paddy rice

| | | plant height | | | culm | ear | number of stems | | |
|---|---|---|---|---|---|---|---|---|---|
| | | (cm) | | | length | length | (per m²) | | |
| | | 7/22 | 8/5 | 8/30 | 10/31 | | 7/22 | 8/5 | 8/30 |
| Compar. | standard | 61.2 | 77.1 | 96.1 | 82.2 | 18.5 | 384.0 | 368.0 | 355.2 |
| Ex. 46 | plot | | | | | | | | |
| Compar. | compost | 61.3 | 77.6 | 98.4 | 81.6 | 19.3 | 406.4 | 364.8 | 358.4 |
| Ex. 47 | plot | | | | | | | | |
| Ex. 47 | Lignin plot | 47.4 | 58.2 | 78.2 | 73.2 | 18.1 | 195.2 | 198.4 | 182.4 |
| Ex. 48 | lignin and | 58.7 | 73.7 | 96.9 | 75.1 | 19.5 | 348.8 | 329.6 | 320.0 |
| | less- | | | | | | | | |
| | amount-of- | | | | | | | | |
| | fertilizer | | | | | | | | |
| | plot | | | | | | | | |
| Ex. 49 | lignin and | 64.7 | 82.2 | 101.5 | 88.2 | 19.6 | 412.8 | 371.2 | 345.6 |
| | normal- | | | | | | | | |
| | amount-of- | | | | | | | | |
| | fertilizer | | | | | | | | |
| | plot | | | | | | | | |

TABLE 37
Phosphoric acid content and Potassium content %

| | | P₂O₅ | | | | K₂O | | | |
|---|---|---|---|---|---|---|---|---|---|
| | | young-panicle | | | | young-panicle | | | |
| | | formation | heading | harvesting | | formation | heading | harvesting | |
| | | stage | stage | stage | | stage | stage | stage | |
| | | foliage | | foliage | paddy | foliage | | foliage | paddy |
| Compar. | standard | 0.64 | 0.54 | 0.21 | 0.57 | 2.96 | 1.90 | 1.42 | 0.40 |
| Ex. 46 | plot | | | | | | | | |
| Compar. | compost | 0.65 | 0.56 | 0.21 | 0.57 | 3.72 | 2.02 | 1.62 | 0.40 |
| Ex. 47 | plot | | | | | | | | |
| Ex. 47 | lignin | 0.66 | 0.52 | 0.17 | 0.66 | 3.16 | 1.80 | 1.51 | 0.39 |
| | plot | | | | | | | | |
| Ex. 48 | lignin | 0.66 | 0.55 | 0.21 | 0.62 | 3.28 | 1.96 | 1.49 | 0.42 |
| | and less- | | | | | | | | |
| | amount-of- | | | | | | | | |
| | fertilizer | | | | | | | | |
| | plot | | | | | | | | |
| Ex. 49 | lignin | 0.59 | 0.57 | 0.24 | 0.50 | 2.84 | 2.01 | 1.74 | 0.32 |
| | and | | | | | | | | |
| | normal- | | | | | | | | |
| | amount-of- | | | | | | | | |
| | fertilizer | | | | | | | | |
| | plot | | | | | | | | |

### Example 8: Fertilizer Efficiency Test Using Lignin (Examples 50 to 51, Comparative Examples 48 to 49)

The cultivation of komatsuna by using sample 1 was evaluated.

In an agricultural field (brown forest soil) in Shimane Prefecture, komatsuna was sown in April. After the passage of five weeks following the sowing, harvesting was performed in May. A commercial fertilizer (base fertilizer [N 150 g, P 150 g, K 150 g] per 10 m²) and lignin as the sample 1 were applied to each test plot as follows. The scale of ridges was such that the cultivation area was 0.32 m² (ridge 80 cm×40 cm×10 cm) and a space between plants was 5 cm. The average weight of the above-ground part of komatsuna and yields thereof were measured (Table 38).

Comparative Example 48: base fertilizer plot (nutrient components, N: 5.0 g, P: 5.0 g, K: 5.0 g (=50 g of 10% fertilizer) for 0.32 m² of one ridge cultivation area)

Example 50: base fertilizer plot+2 kg/a of lignin plowed in soil

Comparative Example 49: Half fertilizer plot (nutrient components, N: 2.5 g, P: 2.5 g, K: 2.5 g (=25 g of 10% fertilizer) for 0.32 m² of one ridge cultivation area)

Example 51: Half fertilizer plot+4 kg/a of lignin plowed in soil

TABLE 38
Above-ground part average weight and yield of komatsuna

| | | | komatsuna | |
|---|---|---|---|---|
| | | | above-ground | yield |
| | | | part average | per test |
| | | test plot | weight(g) | plot(kg) |
| Comparative | not | fertilizer | 50.6 | 1755 |
| Example 48 | added | control plot | | |
| | | (base fertilizer | | |
| | | plot) | | |
| Comparative | | half-amount-of- | 38.5 | 1050 |
| Example 49 | | fertilizer plot | | |
| | | (half fertilizer | | |
| | | plot) | | |
| Example 50 | lignin | fertilizer | 61.8 | 1850 |
| | plot | control plot | | |
| | | (base fertilizer | | |
| | | plot) | | |
| Example 51 | | half-amount-of- | 42.6 | 1225 |
| | | fertilizer plot | | |
| | | (half fertilizer | | |
| | | plot) | | |

When 2 kg/a or more of lignin was applied to the base fertilizer plot or when 4 kg/a or more of lignin was applied to the half fertilizer plot, the average weight of the above-ground part of komatsuna and the yield of komatsuna were increased, hence improved plant growth was observed. In addition, the development of a rhizosphere portion was observed in the lignin-applied plot.

It was found that, in the cultivation of komatsuna, addition of lignin to soil including a reduced amount of fertilizer brought about an increase in fertilizer effects, whereby yield was improved.

The results of Examples reveal that the lignin sulfonic acid component is capable of promoting the growth of various plants and is therefore useful as a plant growth promoter. Furthermore, the results reveal that better physiological conditions are presumed to be brought to plants, and hence lignin sulfonic acid is useful also as a biostimulant.

1. A plant growth promoter, comprising:
a lignin sulfonic acid component,
wherein a phenolic hydroxyl group content of the lignin sulfonic acid component is 0.1% to 3.5% by weight, a methoxyl group content of the lignin sulfonic acid component is 1.0% to 15.0% by weight, and a sulfone group-derived sulfur atom content of the lignin sulfonic acid component is 2.0% by weight or higher.

2. The plant growth promoter according to claim 1, wherein at least one of the following conditions are satisfied:
a reducing sugar content of the lignin sulfonic acid component is 35% by weight or lower;
a sulfur atom content of the lignin sulfonic acid component is 3.0% by weight or higher; and
a sodium atom content of the lignin sulfonic acid component is 0.3% by weight or higher.

3. The plant growth promoter according to claim 1, wherein a carboxyl group content of the lignin sulfonic acid component is 0.1 to 4.5 mmol/g.

4. The plant growth promoter according to claim 1, wherein a weight average molecular weight (RI) of the lignin sulfonic acid component is 3,000 or more.

5. The plant growth promoter according to claim 1, wherein the lignin sulfonic acid comprises a substituent derived from (poly)alkylene oxide.

6. A biostimulant, comprising:
a lignin sulfonic acid component,
wherein a phenolic hydroxyl group content of the lignin sulfonic acid component is 0.1% to 3.5% by weight, a methoxyl group content of the lignin sulfonic acid component is 1.0% to 15.0% by weight, and a sulfone group-derived sulfur atom content of the lignin sulfonic acid component is 2.0% by weight or higher.

7. A method of producing a plant, comprising:
cultivating a plant by using the plant growth promoter according to claim 1.

8. A plant cultivation kit, comprising:
the plant growth promoter according to claim 1; and
a seed or a seedling of a plant.

9. A method of producing a plant, comprising:
cultivating a plant by using the biostimulant according to claim 6.

10. A plant cultivation kit, comprising:
the biostimulant according to claim 6; and
a seed or a seedling of a plant.
